(19) United States
(12) Patent Application Publication
(10) Pub. No.: US 2007/0185744 A1
(43) Pub. Date: Aug. 9, 2007

(54) System and method for providing customized travel guides and itineraries over a distributed network

(76) Inventor: Steven Robertson, Kent, WA (US)

Correspondence Address: PATRICK M. DWYER PC, SUITE 114, 1818 WESTLAKE AVENUE N, SEATTLE, WA, 98109, US

(21) Appl. No.: 11/350,604

(22) Filed: Feb. 9, 2006

(51) Int. Cl. G06Q 10/00

(52) U.S. Cl. 705/5

(57) ABSTRACT

A system and method are disclosed for providing a customized travel guide and customized travel itinerary, combining segments from multiple travel service providers. The system programmatically creates itineraries, checking for time constraints and interferences. Travelers prioritize activities allowing for a traveler to instruct the service to expand or shrink the trip time to include all activities of highest priority, or vice versa. In addition, the service can make recommendations for activities and scheduling based upon the traveler's profile, other traveler's ratings and recommendations, and similar user profiles. Output can be used in an offline mode, or, upon connecting to the online service, take advantage of automatic alarms and updates should the planned activities data change. With the addition of a GPS locating device, or through tracking the dates of travel, the system is able to present the traveler with only the data most relevant to their location while traveling.

### TECHNICAL FIELD

The invention relates to systems for planning and executing travel; more particularly, it relates to system and method for providing customized travel guides and itineraries over a distributed network.

### BACKGROUND OF THE INVENTION

Traveler's planning for upcoming trips may include arrangements for hotels, car rentals, maps, air, train and bus travel and area attractions, such as local tours, theater, restaurants, clubs, museums, festivals, parks, entertainment, gardens and any attraction that can be imagined to be of interest. Travelers can plan trips in several ways. They may use fixed tour itineraries from a well-known tour operator or organization, use tour itineraries from guidebooks, or pay travel planners or agents large fees to create customized itineraries. Alternately, travelers and travel agents research on their own, using guidebooks, such as those published by Rough Guides, Lonely Planet, Insight Guides, Fodor's and Frommer's. Such research is time consuming and expensive as the most recent guidebooks must be consulted. Even the most recent guidebooks cannot be trusted to have changes in travel information that has been made in the year prior to publishing, let alone in the last few weeks. Using guidebooks travelers create their own itinerary documents. Travelers must then carry these itinerary documents and, often multiple guidebooks, with them on the trip. Once on the road, it is difficult and time consuming, if not impossible, to update their preselected travel information.

More popular currently is to perform searches using online search engines such as MSN, Yahoo, or Google and then visit multiple web sites specific to each location or attraction, or to browse randomly to get ideas on which places to visit or which packaged tours to purchase. Due to the overwhelming amount of information available on the Internet, this method is prohibitively time consuming and there is no guarantee that a traveler will find the information most pertinent to their unique interests.

For a long time, airlines have provided printable travel itineraries online of the air travel portion of a trip. Similarly, if air, hotel and car are booked through an online service, a printable itinerary for those items will be provided. Some systems directed to travel by car have been devised for planning and revising an itinerary based on intended travel time and expected time spent in each place. It should be noted that these systems rely on the traveler themselves to provide the locations and attractions that are to be visited, essentially requiring the traveler to have their itinerary and list of events already in hand before using the system. Also, a system for driving trips exists which will allow a traveler to manually build their itinerary by preselecting then placing each desired activity into a linear time line. The system assigns a time allotment for each type of activity and alerts the traveler if they have not allotted a sufficient amount of time for driving to or accomplishing the selected activity. The system offers no more assistance in building the itinerary than a check of time allotment and sufficient rest stops.

None of the above systems provide descriptive information about activities, events and locations, nor do they provide information from multiple vendors of tours, sporting locations and goods, restaurants and other travel needs. Such systems also do not alert travelers as to specific constraints in their scheduling, such as the dates museums are closed, tours are not offered and other scheduling considerations. No known systems are designed to use customer profiles, customer ratings or customer assigned priorities to build an itinerary and customized travel guide or to make recommendations as to attractions, activities and events.

Regarding the creation of customized guides, there are existing travel web sites that allow the tagging of specific pieces of travel information that are later aggregated into a single document, such as a PDF-formatted file, however, these sites do not provide programmatic checks for constraints and conflicts, such as for instance that certain tours can only start on certain days of the week and that multiple day-long tours cannot be scheduled on the same day, nor do they provide any of the other benefits disclosed herein.

What is needed is a central site or service, where the user can choose a location or multiple locations of interest and have information filtered and presented to them regarding all aspects of their trip. Optimally, a system is needed through which a traveler could interactively enter customizing criteria such as the dates for travel and their personal interests and receive specific recommendations of activities, events and locations to visit. A system is needed which can build an itinerary and accompanying guide programmatically for a traveler with a minimum of traveler input, programmatically handling any constraints or conflicts in the scheduling. The system should then also allow the traveler to edit, or otherwise interact with, the itinerary and guide to further accommodate their choices and prioritizations of activities, providing the output travel information in the form of a customized itinerary with corresponding customized travel guide.

### DISCLOSURE OF THE INVENTION

An online customized travel guide and itinerary service for planning all aspects of a trip provided by multiple service providers, including transportation, lodging, tours and activities is disclosed. The system and method provide a central site or service, where the user can enter as much or as little information as they choose for upcoming travel. The system responds by presenting to the traveler from databases accessible to the system selected information regarding all aspects of their trip. Optimally, a traveler enters customizing criteria such as their personal interests and trip priorities, and receives specific recommendations of activities, events and locations to visit from the system that are in accord with, and generated by these criteria. Preferably, the system and method builds an itinerary programmatically for a traveler, from as much or as little information as the traveler chooses to input, programmatically handling any constraints or conflicts in the scheduling, and then allowing the traveler to request that the itinerary be regenerated programmatically to accommodate their further choices of activities and other travel priorities. This information is then provided in the form of a customized itinerary with optional corresponding customized travel guide, which can be printed by the traveler or preferably accessed electronically through multiple devices, such as web browsers, PDA's or cell phones.

As used in this application, “traveler” means any user of the system or beneficiary of the method. While most often “traveler” is used to refer to an individual who is planning on taking a trip, users of the system could also be travel agents or consultants, service providers who wish to combine their services with other aspects of a traveler's plans, tour directors, teachers and any other individuals who find the system useful. For example, a person registers with the travel site or service and obtains a unique ID. In addition, she creates an itinerary, which is also assigned a unique ID. At a later time, this person visits a travel agency either in person or via the Internet and decides to book a tour. This person gives the travel agent her unique ID, and the ID for the itinerary. The travel agency is also a registered user of the travel site or service. Hence, as the travel agent adds the new tour information into their internal system along with the traveler's ID's, the traveler's itinerary is programmatically updated with the new tour information.

The system provides customized travel information for a traveler over a distributed network, the travel information preferably in the form of a customized travel itinerary or a customized travel guide or both. At least one computer hosts a travel site operatively connected to a distributed network. The system and method of the present invention are advantageously suited for use over a public network such as the Internet due to its widespread availability. When used in conjunction with “network”, the term “public” is intended to imply that the user's access to the network is not controlled by or limited to a particular business entity or group of business entities. Likewise, the term “distributed” implies that processing capabilities and services are advantageously spread out among different nodes of the network with different nodes providing different services, as opposed to being centralized within a single host, server or LAN. In general, however, the system and method can be used on any type of distributed network over which online services are provided by service providers to end users, including both public and private, and hybrid public-private networks.

Through the distributed network or alternatively by manual data entry, the system is connected to sources or databases of travel information, advantageously both public and private. Information may be exchanged through shared software applications running on multiple computing devices, such software distributed through partnerships with travel service providers, or information may be gathered by programmatic devices well known in the art, such as web crawlers, spider's and data miners, or any device for information gathering now known or later developed.

In one embodiment, the travel site is connected to one or more databases of information necessary for the accomplishment of the system's purposes. A travel content database contains typical information found in travel guides such as country and city information and information about attractions and activities of interest, including, but not limited to, descriptions, hours, costs, and photos. Continuing with this embodiment's description, a business rules and recommendations database contains the logic behind the system for making programmatic suggestions based for instance on user profile, user selections, date and time of travel, or any other rules and constraints regarding events or activities, such as for example, that they must start on a Friday or that the duration must be 4 hours. A service provider database contains information on details of service providers. For example, this database contains what tours are offered by tour operators, hotel names and locations, or other transportation details. A traveler database contains membership information, such as passwords, profiles, preferences, priorities and any already associated customized travel guides and customized travel itineraries appropriately linked to the traveler's unique identifier. A traveler ratings and suggestions database contains ratings of service providers given by travelers as well as any travel suggestions they might have for fellow travelers. The number and contents of databases described for the above embodiment does not limit this disclosure from the use of any other database configurations which may be used for the accomplishment of the system's output.

Through at least one input device, a traveler accesses the travel site and inputs data. Through at least one output device, a traveler accesses the travel site and receives selected output. The input and output devices may be the same or different devices. Input and output may be delivered or received in any mode currently known or later developed, including but not limited to an interactive mode, a one way, streaming, mode or batch processing. For example, in a preferred embodiment, the traveler accesses the travel site through a browser running on a computer and engages in an iterative process of making choices for their travel plans. Through the browser, the traveler gives the system input regarding their desired travel and receives an itinerary and guide output based on that input. The traveler reviews the itinerary and guide, then gives the program further instructions and choices regarding the construction of the itinerary and guide and the system programmatically regenerates and outputs a revised itinerary and guide. In this example, this is all accomplished on the same computer. Alternatively, a user may generate an itinerary by inputting choices through a cell phone keypad ahead of the trip, and receive their day's itinerary on the road, based on a GPS transmitted location, and displayed on their PDA with perhaps no further interaction possible.

Programmatic processing is accomplished by an application running on the travel site. Alternatively, software components may be run on user's computers as well, in which case necessary software components are made available to the users. Hereafter, the term “travel site application” refers to the application running on the travel site or a combination of applications working together throughout the distributed network to substantially the same effect.

In some circumstances, this travel site application may be implemented on a desktop or portable computer. By providing appropriate hooks, links or other online search and retrieve functions now known or later developed, a traveler using such a desktop application can query and create her own itinerary, as otherwise described herein, without otherwise appearing to access a remote travel site.

The travel site application is adapted to accept and process at least one piece of information from a traveler regarding a proposed trip, find a corresponding or related piece of information from one or more of the databases, apply the application's business rules, searches and constraints, and generate customized travel information for the traveler, preferably in the form of a customized travel itinerary or a customized travel guide or both. For example, a traveler may input to the system the information that they wish to travel to Paris and visit as many museums as possible over the course of 8 days. The application applies the traveler's request to information regarding various museums in Paris, such as other travelers' rating of the museums, constraints regarding the opening hours and days of the museums, estimated visit durations for viewing each museum and such various museum tours as are offered. Having parsed all this data, the application generates a recommended itinerary and a companion travel guide. The itinerary spans the appropriate dates and days of the week to maximize museum accessibility during the trip. The highest prioritized museums are scheduled into time slots of appropriate duration over the 8 day period with time left for meals and travel to and from the museums. In addition, the system recommends several localized hotels, using the traveler's previously created itineraries and hotel choices to match a probable cost preference to the highest possible hotel ratings in the area. The companion guide contains the information regarding the museums, tours, restaurants, night life, parks and other attractions in the area selected for the hotels. The traveler is now free to review or print the itinerary and guide or to submit additional choices to further customize the travel planning output.

Optimally, information in the companion guide is placed into categories allowing for the grouping of similar information. The categories may be further subdivided. For example, countries may be divided into regions, regions into cities, cities further divided into city sections and still further divided into transportation options, hotels, restaurants, attractions and other categories, as is done in most guidebooks currently available. Additionally, information may be divided into geographic locations and used to create customized maps showing the locations of items of interest. Such maps are useful for the design of walking tours, or physically finding items of interest. GPS way points optionally are provided to assist a traveler in locating items of interest.

Advantageously, the travel site application is adapted to retrieve data for a traveler according to the traveler's stored prior choices, a traveler's prioritizing of their choices, a traveler's previously stored itinerary data, and optionally according to data from a database of traveler ratings and suggestions. The travel site application can then use this data to make suggestions of travel items to the traveler. During a process of building and editing an itinerary, the traveler is provided with information on subjects such as possible countries, regions, cities, activities, attractions, dining, and lodging to be selected. The time saving and convenience resulting from being presented only with such information as is relevant is believed to be of particular benefit to the traveler/user. The application can include this data in a customized guide or use the data to make suggestions to the traveler through a trial or draft itinerary, a message box, listbox, checklist or other devises known to those skilled in the art for communicating with or eliciting selections from the user. The traveler can then select further items to be included in a revised itinerary or guide or both. For example, the system can extract from a traveler's previously stored itinerary for a trip to Lisbon, Portugal, that this traveler scheduled stops at numerous Roman Catholic cathedrals or that the traveler rated a cathedral very highly on return. During the building of the museum tour of Paris used as an example above, the system accesses this information, then finds Roman Catholic cathedrals that are rated high by other travelers in an information source of other traveler's ratings and recommendations. The system displays a listbox of the cathedrals offering the traveler an option to select and display more information for each or the option of dragging and dropping the selected cathedral into their itinerary or guide.

In preferred embodiments, travelers also have the option of reviewing other travelers' ratings and recommendations for locations, attractions, service providers and activities while making choices for the itinerary and guide.

While the user is preferably guided through the trip planning process in a selected order of steps, users can also build their itineraries in any order, skipping steps if they so desire and returning to them later.

Optimally, the traveler inputs a priority for each chosen item to be included in their itinerary. This allows the travel site application to fill the trip duration time or a trip segment duration time according to the traveler's priorities. For example, a traveler indicates a particular day of their trip, and instructs the travel site application to build the itinerary with a number 1 priority of visiting the castle at Versaille and the number 2 priority of visiting the castle at Chinon, not knowing if such activities take a full day or a couple of hours. The travel site application generates an itinerary for the day with the trip to Versaille, which takes the entire day. The number 2 priority, visiting Chinon is not scheduled.

Traveler's assignment of priorities also allows the travel site application to adjust the duration of the trip or segment to accommodate the inclusion of items prioritized above a selected importance. One benefit from this is that the traveler can arrange that the duration of their itinerary be dynamically adjusted, by either having items eliminated with lower priorities or eliminating items based on other criteria, such as eliminating countries, regions, cities or tours. For example, a traveler visiting museums in Paris assigns a priority of from 1-5 to each of 12 museums. The travel site application generates an itinerary for visiting all 12 museums. Adjusting for travel times and accessing information on the recommended time spent in each museum, and the trip is scheduled over a trip duration of 28 days. The traveler can only spend 14 days, and therefore, instructs the travel site application, to regenerate the itinerary using only museums that were prioritized at 3 or higher. This results in a trip duration of 11 days, which the traveler is able to edit to their satisfaction.

In one embodiment, the travel site application is advantageously adapted to display the customized itinerary to the traveler in time period blocks for the purposes of viewing and editing. Time periods can be individual days of 24 hours, half days of 8 hours, 3 hour blocks for activities, 1 and 2 hour blocks for meals or any other useful time periods. The traveler is provided with an interface allowing her to custom build and edit the selected time period durations, with items for each time period, adding new choices from the information provided, deleting and rearranging other travel choices. The traveler progresses from one time period to another until satisfied with the editing process and the entire itinerary and guide are regenerated and redisplayed. For example, in the Paris museum trip planned above, a traveler may decide to delete the trip to the Picasso museum and instead insert a walking tour of the Latin Quarter instead. Optimally, the travel site application pops up an alarm should the traveler break one of the rules or constraints of the program. For example, if they tried to schedule the Latin Quarter tour at a time or day it was not offered, a message box displays, alerting them to that fact and perhaps offering an alternative tour.

Preferably, when the travel site application is adapted to generate the customized travel itinerary in time period blocks as above, the traveler is allowed to add, delete and reorder itinerary time period blocks according to their choices. For example, a traveler can delete a half day and shorten the trip, add 2 half days to add a rest day or move 2 very strenuous days further apart in the schedule, traveler selected or approved travel constraints permitting. Optimally, the system can be instructed by the traveler to programmatically expand or shrink the itinerary to include or exclude certain selected items or all items of a selected level of priority. The travel site application then regenerates the customized travel itinerary, accordingly changing the trip duration and redelivers the itinerary to the traveler.

Advantageously, the travel site application is adapted to accept the proposed dates of travel from a traveler and to use these specific dates when generating the itinerary. It is possible for the trip to be planned using the proposed dates and times it will span. For example, if a certain museum is scheduled to be closed for remodeling over certain dates, it is not included in the itinerary. Optionally, a message box alerts the traveler to the date constraint and, if the traveler has given that choice a particular priority, recommends changing the dates of the trip to a time when the museum is open for business.

Optimally, once an itinerary has been generated and stored for the traveler's use, the travel site application is adapted to alert the traveler should the planned activities data change. Optionally, this can be programmed to occur upon the traveler's next connection to the online customized travel guide and itinerary service, or by other means of notification such as email generation, instant messaging or cell phone text messaging.

In one embodiment, all or part of the traveler's choices, the traveler's itinerary and the travel guide are stored locally on the traveler's computing device. This device might be a desktop computer, a laptop computer, or some other mobile device such as a PDA or cell phone. This provides the benefit of accessing the travel content while disconnected from the network. Optionally, the user's customized itineraries and travel guides are used in an offline mode, or, upon connecting to the online customized travel guide and itinerary service, take advantage of automatic alarms and updates should the planned activities data change. If software is installed on the user's device as disclosed above, only the relevant sections of the itinerary or guide need be displayed to the traveler. This has the advantage that the traveler does not have to search through the entire trip travel content to find the information they need.

In another embodiment, a stand-alone application resides on the traveler's computing device, as disclosed above, that optionally updates its content from the centralized server, and is adapted to perform all the functionality of the travel site application offline.

Another embodiment allows the itinerary that is stored on the centralized server to be accessed by a mobile device while in transit and limit the display of the itinerary to just the part that is currently relevant based on criteria such as location or date and time. Thus, for example, a traveler in Vietnam, accesses their itinerary on their cell phone, the centralized system knows where the traveler is and presents just the relevant information, such as lodging and dining for the current city. The system determines the traveler's location either by GPS coordinates sent from the mobile unit, by using the stored itinerary to determine where they are supposed to be, or by optional manual traveler input. Again, this embodiment has the advantage that only the relevant portion of the itinerary or guide need be displayed to the traveler.

Another embodiment uses GPS coordinates to create walking or driving tours and identify points of interest or photo-taking spots. GPS data is optionally stored not only for attractions, but also for lodging establishments, restaurants and other places of interest.

A method for providing customized travel information for a traveler over a distributed network, preferably in the form of a customized travel itinerary or a customized travel guide or both, is also disclosed. In one embodiment, information regarding travel plans is received from a traveler, this information is used to select relevant information from stored or gathered travel information to construct a customized guide and itinerary for the planned trip. The programmatic logic of the travel site application builds the itinerary without scheduling conflict, or optionally permitting some such conflicts, but alerting the traveler to them, and with adequate time allotted for each item, such as tours, activities and travel segments.

For example, a traveler accesses a travel planning site via the Internet and enters the information that they wish to travel to Italy and see Venice, Florence and Rome. They also enter that their first priority is to study landscape architecture of the individual cities, and secondly would like to attend some opera performances. Programmatically, the system accesses information on all local attractions with gardens, garden tours that are available and landscape architects that are doing business in the selected cities. Programmatically, the travel site application determines the dates for the trip by optimizing the number of attractions, tours and open landscape architectural businesses available in each location. The system then accesses information on opera performances in the cities and recalculates the dates for inclusion of this second priority. The travel site application then builds the itinerary, placing tours, opera performances, self guided tours, visits to local landscape architects, travel times and meal breaks into the logical time segments for each city. The system then accesses transportation vendors' schedules and places the intercity travel into the itinerary expanding the trip dates as necessary. The customized guide is created with all relevant data, including alternate attractions, information about other services that might be necessary, recommended hotel accommodations and restaurants, schedules for the relevant activities and any other information the traveler could find in a hard copy guidebook for these areas. The customized itinerary and guide are then displayed to the traveler on the computer screen.

The above example illustrates but does not limit a particular embodiment of the disclosed method. The disclosed method may also operate much more simply. For example, a traveler may input only the information that they wish to visit Venice, Florence and Rome. The system then, for example, accesses information on available commercial tours for the 3 cities and the travel site application creates an itinerary placing the tours over the necessary number of trip days with travel days of appropriate intervals in between.

Alternately, in the first step of receiving travel information from a traveler, the traveler may input to the system every location she wishes to visit, every activity she wishes to do and her choice of hotels, restaurants and transportation preferences, and then let the travel site application merely order and build the itinerary using her choices. Another ordering of this step is to receive a minimal amount of information from a traveler in an initial step and, after the next step where relevant information from stored or gathered travel information is selected, the travel site application presents this information to the traveler and allows her to choose which itinerary items will be included in the customized itinerary through a trial or draft itinerary, a message box, listbox, checklist or other devises known to those in the art for communicating with or eliciting selections from the user. The travel site application then constructs a customized itinerary for the planned trip using the traveler's choices.

Optimally, each item placed in the itinerary is assigned the appropriate length of time for the individual item. Items are not required to be assigned a fixed length of time even if viewed as being in the same category. For example, a visit to the Louvre would be assigned a much longer duration of time in the itinerary than the same trip to the Rodin museum, since touring the Louvre would take much longer. This is true whether items are programmatically entered into the itinerary or whether a traveler enters them.

In an alternate embodiment of the method, information regarding travel plans is received from a traveler. This information is used to select relevant information from stored or gathered travel information, and then a traveler is guided step by step through building a customized itinerary for their trip by choosing from the relevant information. In one embodiment of this alternate method, the traveler is presented with time segments of their trip and places choices from the gathered travel information into each time segment of their itinerary. Travelers may also add their own items of interest into the itinerary at any time or have items recommended by the system. After filling the necessary time segments with items of interest, such as tours, activities and attractions, the traveler fills in the necessary transportation segments they will use to travel from location to location during their trip. Using the above example of a trip to Italy, the system has gathered the relevant information on Rome. The traveler chooses to build the itinerary in half day time segments. The travel site application displays the list of possible tours, activities and attractions in Rome to the traveler along with a blank half day schedule. The traveler then adds a commercial tour of gardens to the first time segment, then adds lunch at a nearby restaurant. The commercial tour is long and fills the time segment. Another tour might leave room for yet another activity before lunch The segment being full, the traveler saves that time segment and the travel site application moves the traveler to the next. The traveler adds a visit to the offices of a landscape architectural firm, dinner and an opera performance to the next time segment. Perhaps rather than an opera, the traveler adds a long walk through the city, an item not on the list of choices, by entering it in the schedule. In a preferred method, the traveler can return to any previous time segment and rearrange or delete items of interest. The traveler continues until they are satisfied with the portion of their trip in Rome. The traveler then adds a transportation segment, which takes them to Florence and repeats the above process with the relevant information for Florence. This portion of the method is repeated for each city until the trip itinerary is complete.

In a preferred embodiment of the method, a customized itinerary is generated programmatically by the travel site application and is then output to a traveler in time period blocks of a user chosen duration. The traveler then has the option of editing the programmatically generated itinerary for each block, using other relevant information gathered by the system. This method is similar to the method described above, except that the traveler is presented with populated time segments instead of blank ones to start their editing. The traveler still has the option of rearranging or deleting the scheduled items of interest and adding new ones from the relevant information for the location gathered and presented by the system, or adding their own items to the itinerary.

Advantageously, the method allows a traveler to input days of the week for traveling and/or specific dates of the year for the planned trip. With this time specific information the travel site application generates a customized travel itinerary or guide accommodating such information. For example, a system may accept the input that a traveler wishes to visit Venice, Florence and Rome, and the preferred dates of travel. The system may then access information on available commercial tours for the 3 cities during those dates and create an itinerary placing the tours over the necessary trip days. Tour A may only be available Tuesdays and Thursdays, Tour B may only be available on Friday, while Tour C is available every day of the week, but requires two days with an overnight stay. The programmatic logic of the travel site application builds the itinerary with Tour A on Tuesday, Tour C on Wednesday and Thursday and Tour B on Friday.

In addition, once time specific information is input by the traveler, the travel site application can use time constraints and time interferences during the programmatic generation of the customized itinerary or during the editing of the itinerary by the traveler. For example, in the Italian trip discussed above, suppose a certain garden is only open to the public on the weekends. During the step of programmatic generation, the application logic schedules the tour of this garden on a Saturday or Sunday. Likewise, if it was only open in the afternoon from 1-4 P.M., the travel site application places it in the itinerary during those hours. If a traveler was using the method above of building the itinerary from a blank schedule, or editing an already populated itinerary, in preferred embodiments, should the traveler try to enter the garden tour into the itinerary schedule outside of the open hours, a message box or similar programmatic device informs the traveler of the time constraint.

Following the step of building the customized itinerary, and further presenting it to the traveler in time period blocks, such as hours, half days or days, optionally, the traveler rearranges the order of time periods to suit their choices. For example, a traveler instructs the application to move all the activities so far scheduled for Friday the 13th to Monday the 9th. The activities scheduled for Monday through Thursday, are then programmatically rearranged to be scheduled to Tuesday the 10th through Friday the 13th. Optimally, the application also checks for time constraints upon such rescheduling. In preferred methods, travelers can remove time periods or add time periods in a similar fashion. The application then adds blank time segments, or deletes time segments along with the activities, transportation segments, hotel stays and other parts of the trip that were scheduled into the deleted time segments. The application accommodates the additions and deletions by accordingly shortening or lengthening the itinerary.

In one embodiment of the method, following the step of building the customized itinerary, travelers can simply instruct the travel site application to lengthen or shorten the itinerary. Upon this instruction, the travel site application rebuilds the itinerary to accommodate the new traveler imposed time constraint. The travel site application has many criteria upon which this time constraint can be accomplished. With no further input from the traveler, the travel site application may use ratings such as those obtained from other travelers, guidebooks and Internet sources, to add or delete itinerary items. In preferred systems, the traveler has prioritized the itinerary items, either during the step of their initial input, or later when the itinerary and accompanying guidebook is presented, or just before the step of instructing the travel site application to lengthen or shorten the itinerary. For example for the trip to Italy above, the traveler already input, along with the cities and dates, that all activities for studying landscape architecture should have the first priority, while attending opera performances was a second priority. Optimally, travelers are able to prioritize a list of activity categories or, most desirably, a list of selected itinerary items which has been culled for the traveler by the travel site application. After such prioritizing, the traveler, for example, instructs the travel site application to change the duration of the trip by regenerating the itinerary including all activities above a certain priority, or excluding all activities below a chosen priority.

In preferred methods, upon accessing the travel site application, a traveler creates a profile, which is stored with a unique identifier for the traveler. This allows a traveler to leave the travel itinerary process at any point and resume at a later time. It also allows travelers to have multiple itineraries and guidebooks stored in the system. This particular practice is itself well known in the art, though not as part of the overall disclosed method.

In preferred embodiments, the travel site application presents the traveler with travel recommendations or suggestions. This step may be performed during any or all of the steps of selecting relevant information from stored or gathered travel information, presenting of the programmatically created itinerary or guidebook, or guiding the traveler through the building or editing of their own itinerary. These recommendations are gathered outside of the normal step of selecting relevant information based upon the traveler's initial input for this itinerary. The recommendations may be for alternate scheduling of itinerary items or for inclusion of alternate itinerary items, such as tours, activities or attractions. There are any number of criteria that the travel site application may use to obtain and present these additional recommendations and suggestions, such as the traveler's history (previously chosen itinerary items and priorities), other traveler's ratings of items in the input location and similar users' profiles and histories. Traveler's are, of course, given the opportunity of including these recommendations in the current itinerary, after which the travel site application rebuilds the itinerary with the inclusion.

Advantageously, it is possible to form relationships or links between itineraries. Such relationships are well known in the art and often referred to as master/slave or parent/child relationships. For example, the head of the family creates the main or master itinerary for the family. This master itinerary sets the parameters for what is possible for the slave itineraries. A slave itinerary is created for a subgroup of the family to do different activities than the main family, but is not allowed to change the basic information such as location and lodging. It only allows the changing of activities. The travel site application makes sure that any activities chosen do not conflict with other criteria such as location. The system also defaults to a display a copy of the master itinerary activities upon login by of the family. Optionally, the system handles the master/slave itineraries as two separate, but linked, itineraries or as multiple simultaneous time blocks that occur parallel to each other. Furthermore, the head of the family who created the master itinerary may place further restrictions on what is possible in the slave itineraries. For example, not allowed to modify lunch, dinner, or certain activities, such as an evening theater performance, but allowed to modify activities that occur in the morning and afternoon. This would allow teenagers to go off on their own and do activities more of interest to them and still meet back up with the family at other times.

During the initial input of information, a traveler might also indicate family size which may limit lodging, transportation options or even activities. This would affect items recommended by the system also based on preferences of activities of individual family members. For example, if the family has young children, then the system might recommend activities that are fun for children as well as adults.

Once a traveler's itinerary is created, optimally, the travel site application searches for updates to the itinerary's travel information. Frequency of such searches can be selected by the traveler or programmatically controlled. For example, the travel site application generates an itinerary for a traveler 2 months in advance of a trip. The traveler then instructs the travel site application to check for any changes in the itinerary information once a week until departure and twice a day after the trip begins. Should any information change, the travel site application generates updates or alarms to be communicated to the traveler in any of the commonly known methods listed above or those to yet be developed. These alarms can be communicated before the trip or during a trip. For example, after the traveler leaves for Italy, one of the stately homes offering a garden tour in Florence is sold. Upon arrival in Rome, the traveler checks his email via the Internet at the airport and, receives a message that the garden tour scheduled is no longer available. The message includes several suggestions for replacement activities and a recommendation that the traveler can receive a revised itinerary from the travel site application online.

Additionally, the travel site application searches for relevant travel information by periodically repeating the step described above for making initial recommendations and suggestions and makes new recommendations for changes to the itinerary based upon newly obtained travel information. Suppose a renowned landscape architect schedules a lecture tour after the traveler to Italy has created their itinerary. The travel site application discovers this while searching for relevant information, creates an update notice and communicates it to the traveler.

Travelers may accomplish the step of accessing their itinerary in many ways once it has been generated. They may receive itinerary information over phone connections, PDA's, laptop computers and any other communication method now known or later developed. In preferred methods, the travel site application selects only the relevant portion of the itinerary and guidebook to display to the traveler. For example, after visiting Rome and moving on to Florence, a traveler need not sort or scroll through the Rome segment of the itinerary and guidebook. The travel application receives GPS coordinates from a handheld device, or programmatically matches the current date with the date for arrival in Florence according to the itinerary, and displays the current day's schedule, along with multiple restaurants in the section of Florence where these activities occur, to the traveler on their palm top computer.

The above disclosure is not by way of limitation and does not exclude any variations of the disclosed method that may occur to those skilled in the art.

The above disclosed system and method provide a service for creating a customized travel guide and itinerary. The system and method allow for the interactive and iterative planning of all aspects of a trip including the combination of segments provided by multiple service providers, such as tours, transportation segments, lodging and activities. In a preferred embodiment, the user may input as little or as much information about their choices for the trip as they wish, and the system programmatically generates an itinerary and guide. One aspect of the service is that while creating the itinerary, it checks for time constraints and interferences, such as dates museums are closed, times tours are offered and whether scheduled events allow enough time for each to be done in the time period allotted. Additionally, in a preferred embodiment travelers prioritize their activities. This allows the system to programmatically generate an optimized itinerary and allows for a traveler to instruct the online service to expand or shrink the trip time to include all activities of highest priority, or to expand or shrink the planned activities to fit the available time. In one embodiment, time period increments, such as half day increments, are selected and the itinerary is edited period by period by the traveler. While the user is guided through the trip planning process, travelers can edit their itineraries in any order, skipping steps if they so desire and returning to them later. In addition, the service can make recommendations for activities and scheduling based upon the traveler's preference data, the traveler's prioritizing of travel choices, stored traveler's ratings and recommendations, and similar user profiles. Advantageously, the itineraries and guidebooks are stored in a device independent format and can later be retrieved on web browsers or hand held devices. The user's customized itineraries and travel guides can be used in an offline mode, or, upon connecting to the online customized travel guide and itinerary service, take advantage of automatic alarms and updates should the planned activities data change. With the addition of a GPS locating device, or through tracking the dates of travel, the system is able to present the traveler with only the data most relevant to their location while traveling.

### BRIEF DESCRIPTION OF THE DRAWINGS

FIG. 1 is a block diagram illustrating the general architecture of a system, which operates in accordance with the present invention.

FIG. 2 is a flowchart illustrating the Traveler registration process.

FIG. 3 is a flowchart illustrating the Traveler profile modification process.

FIG. 4 is a flowchart illustrating the process of maintaining the Traveler's itineraries.

FIG. 5 is a flowchart illustrating the manual workflow of selecting countries of interest.

FIG. 6 is a flowchart illustrating the manual workflow of selecting regions of interest.

FIG. 7 is a flowchart illustrating the manual workflow of selecting cities of interest.

FIG. 8 is a flowchart illustrating the manual workflow of selecting items of interest.

FIG. 9 is a flowchart illustrating the manual workflow of selecting tours of interest.

FIG. 10 is a flowchart illustrating the manual workflow of selecting lodging establishments of interest.

FIG. 11 is a flowchart illustrating the manual workflow of selecting the “How” of the Itinerary.

FIG. 12 is a flowchart illustrating the manual workflow of Building Day Segments.

FIG. 13 is a flowchart illustrating the manual workflow of adding or modifying an existing Day Segment.

FIG. 14 is a flowchart illustrating the manual workflow of Building Trip Days.

FIG. 15 is a flowchart illustrating the manual workflow of adding or modifying an existing Trip Day.

FIG. 16 is a flowchart illustrating the manual workflow of Ordering Trip Days.

FIG. 17 is a flowchart illustrating the manual workflow of Building Transportation Segments.

FIG. 18 is a flowchart illustrating the manual workflow of adding or modifying an existing Transportation Segment.

FIG. 19 is a flowchart illustrating the process of generating a Customized Travel Guide or Itinerary.

FIG. 20 is a flowchart illustrating the process of the Itinerary Wizard for Defining the Desired Locations.

FIG. 21 is a flowchart illustrating the process of the Itinerary Wizard for Defining the Activities and Attractions at the Desired Locations.

FIG. 22 is a flowchart illustrating the process of the Itinerary Wizard Looping Through the Selected Countries and Cities to define the Items of Interest.

FIG. 23 is a flowchart illustrating the process of the Itinerary Wizard for assigning Items of Interest to Day Segments.

FIG. 24 is a flowchart illustrating the process of viewing, Tagging, Rating, and Providing Recommendations on a Location.

FIG. 25 is a flowchart illustrating the process of Viewing, Tagging, Rating, and Providing Recommendations on a Service Provider.

FIG. 26 is a flowchart illustrating the process of Viewing, Tagging, Rating, and Providing Recommendations on an Activity or Attraction.

FIG. 27 is a Data Model of the ‘Activity’ subject area of the content database.

FIG. 28 is a Data Model of the ‘Geographic’ subject area of the content database.

FIG. 29 is a Data Model of the ‘Itinerary’ subject area of the content database.

FIG. 30 is a Data Model of the ‘Lodging’ subject area of the content database.

FIG. 31 is a Data Model of the ‘Ranking’ subject area of the content database.

FIG. 32 is a Data Model of the ‘Tour’ subject area of the content database.

FIG. 33 is a Data Model of the ‘Transportation’ subject area of the content database.

### BEST MODE OF CARRYING OUT THE INVENTION

As used in this application, “traveler” means any user of the system or beneficiary of the method. While most often “traveler” is used to refer to an individual who is planning on taking a trip, users of the system could also be travel agents or consultants, service providers who wish to combine their services with other aspects of a traveler's plans, tour directors, teachers and any other individuals who find the system useful. In addition, reference in this disclosure to an “online travel site” also includes, in some cases, the use of installed software on a user's computer, or a user network, which performs functions similar to those provided on the online site, and which merely checks in online for data. The term “itinerary”, as used in this application includes travel output, in whole or in part, through video display or documents in formats now known or yet to be developed, such as a time schedule, calendar or map.

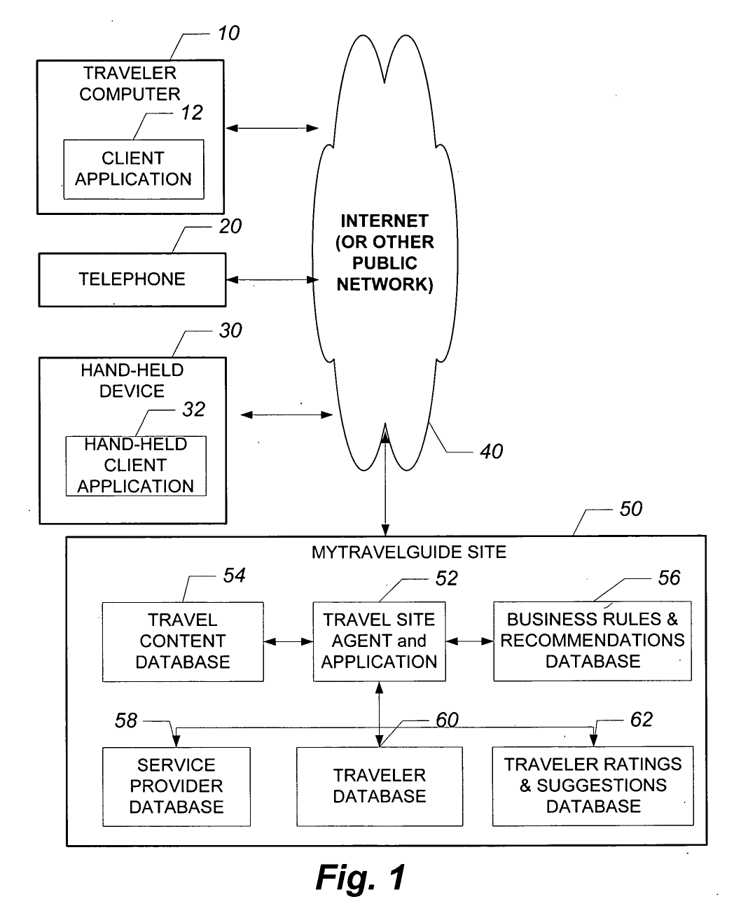

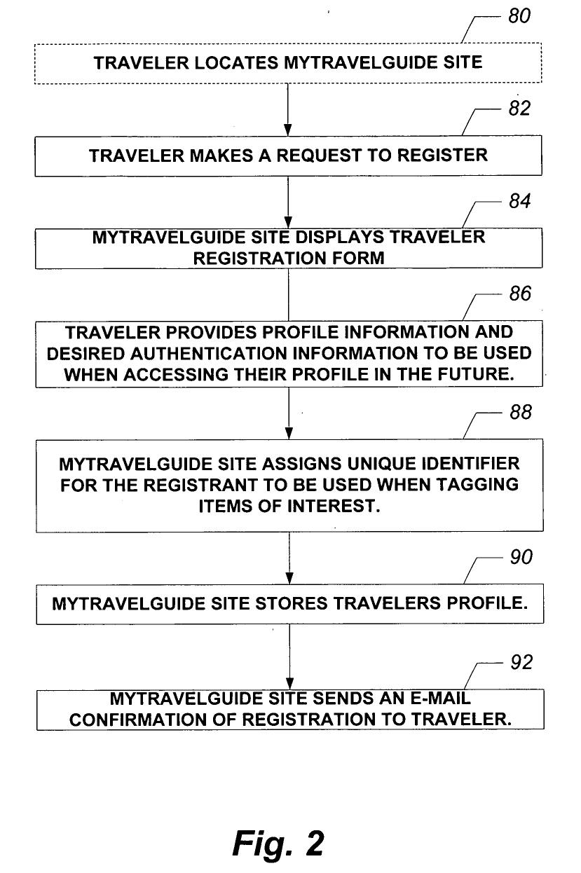

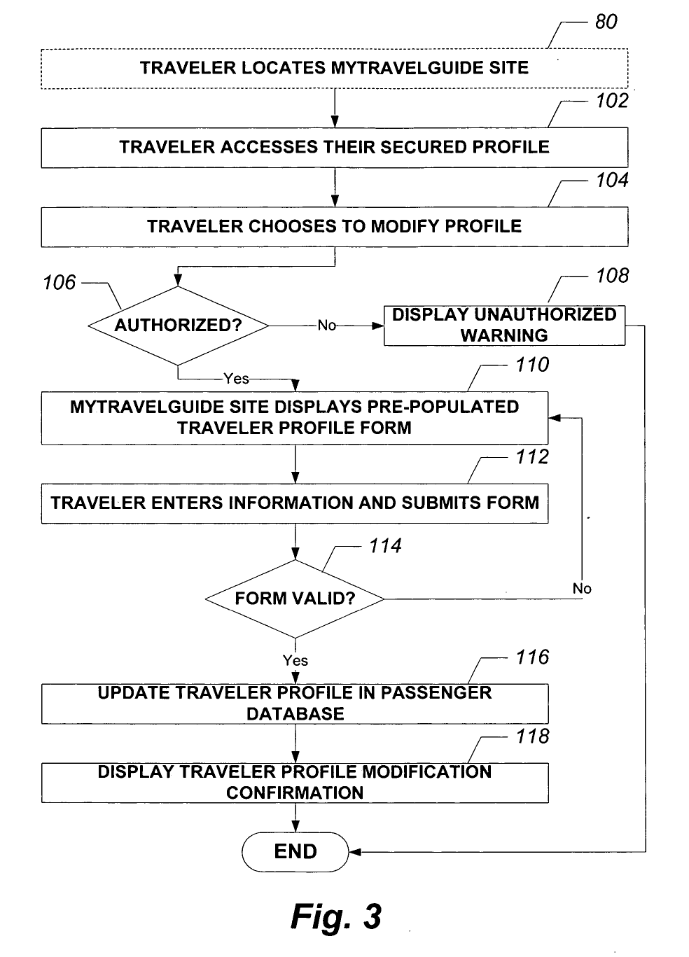

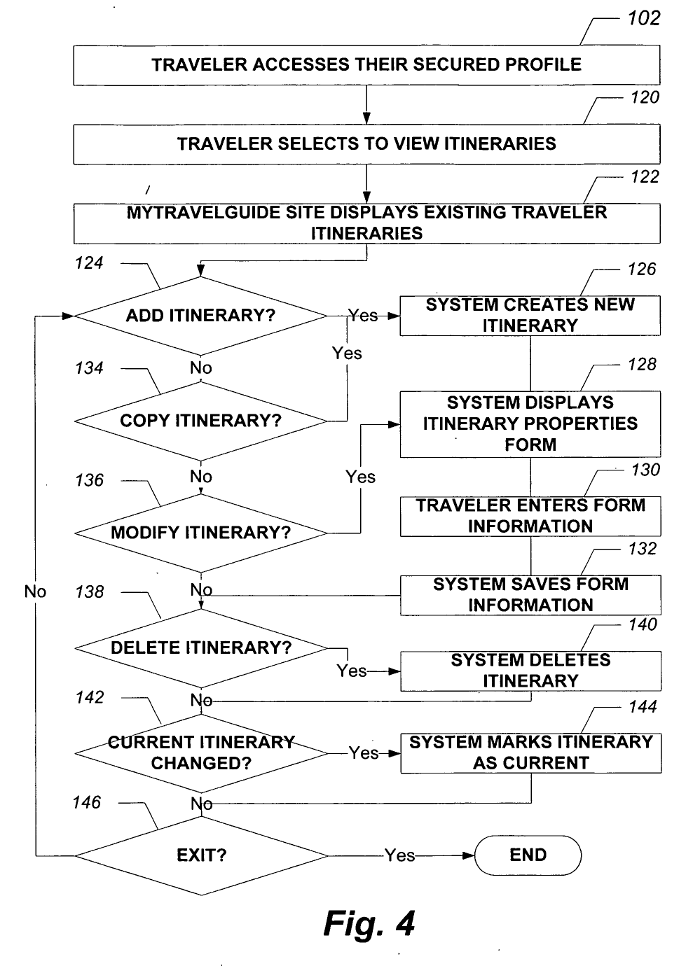

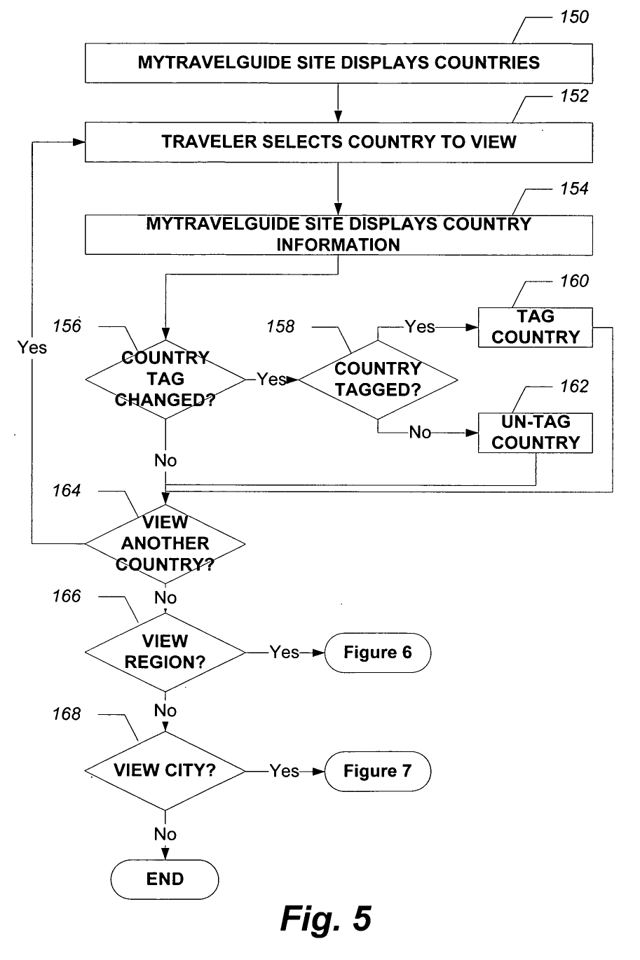

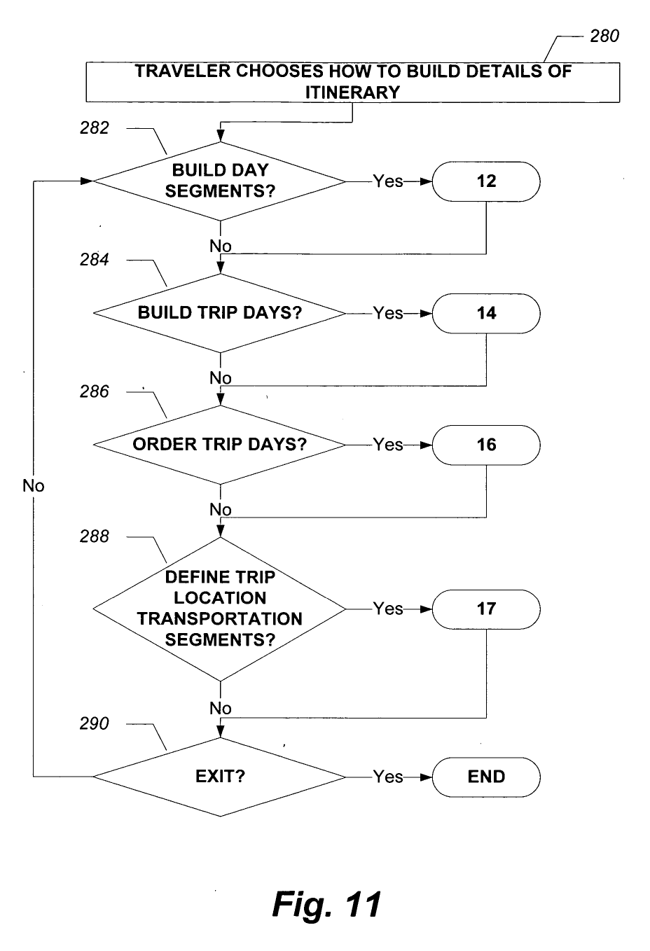

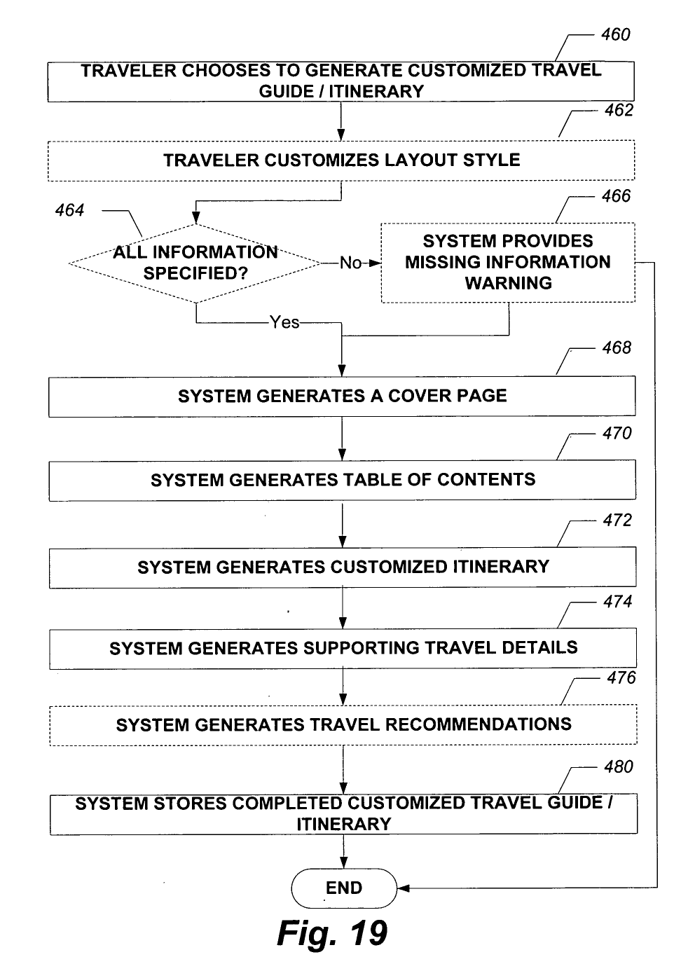

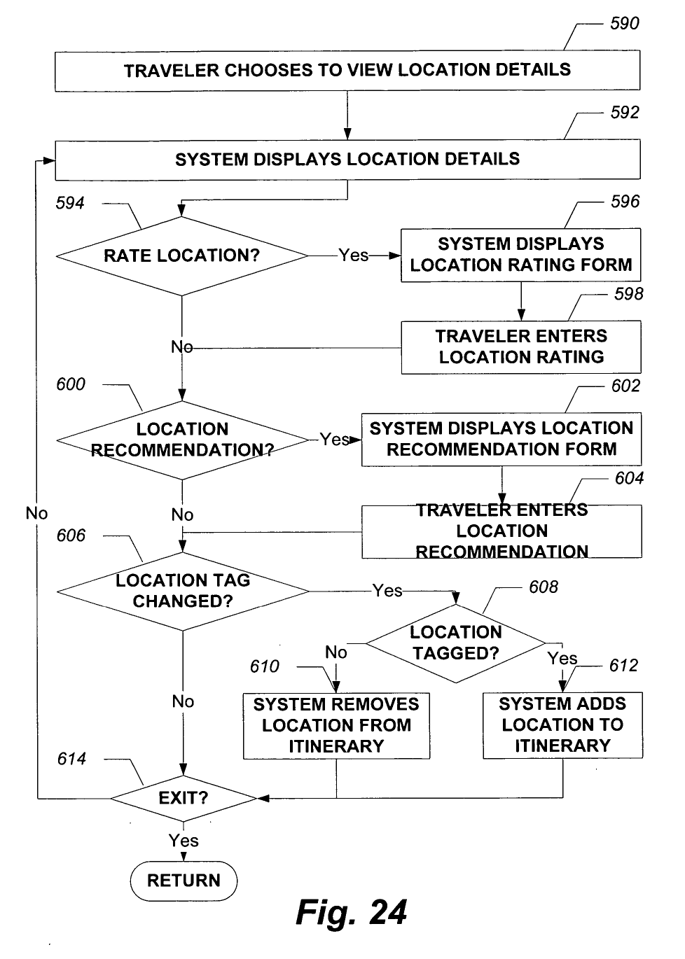

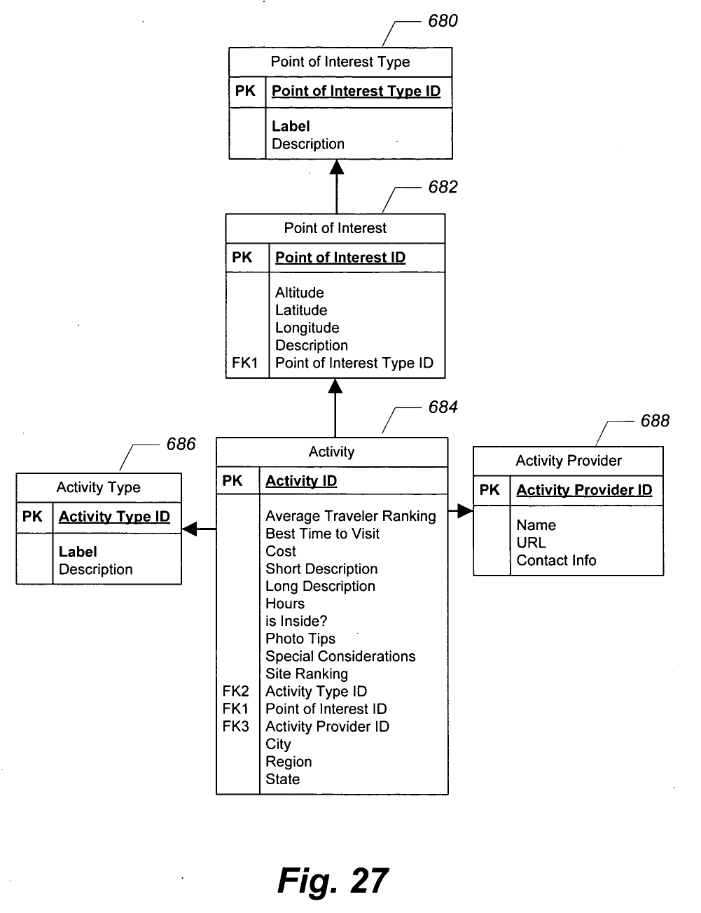

Turning now to the drawings, the invention will be described in particular embodiment by reference to the numerals of the drawing figures wherein like numbers indicate like parts. The basic components and features of preferred embodiments are initially described with reference to FIG. 1. Registration of travelers is described with reference to FIGS. 2-3. Processes used by the traveler to maintain their itinerary are described in FIG. 4. Manual workflow of selecting what to see and do is described in FIGS. 5-10. Manual workflow of determining how the itinerary is to be viewed and edited is described in FIGS. 11-18. An automatic process of creating a customized Travel Guide and/or Itinerary is described in FIGS. 19-24. Processes for viewing the details on Locations, Service Providers, and Activities or attractions are described in FIGS. 24-26. Finally, data models for the content are described in FIGS. 27-33.

FIG. 1 illustrates basic components of a system that operates in accordance with the present disclosure. Users (also referred to as “customers”, “passengers”, or “travelers”) connect to the Internet 40 (or other distributed public network) via either user computers 10, telephones 20, or hand-held devices 30, such as Palm and Windows CE devices, to perform transactions, to create customized itineraries and corresponding travel guides, modify their personal profile, read travel related information, provide recommendations, or rate service providers. Registered users are those which have previously accessed the online travel site and have created a personal profile linked to a unique identifier.

The registered users may connect to the Internet 40 in any known manner. For example, the users may use a suitable online services network to obtain access to the Internet, or may connect by establishing an account with an Internet service provider. Each user computer 10 includes at least one client application 12, such as a World Wide Web browser, for communicating with server application (also referred to herein as “Travel Site Agent” and “Travel Site Application”) 52 on the Internet 40.

Although the user computers 10 are shown as being directly connected to the Internet 40, it should be understood that such connection may be via one or more private networks. For example, a user computer 10 may connect to the Internet 40 via a wireless connection or via a private cable televisions network using a cable modem.

Similar to user computers 10, users may also access an online travel site 50 (referred to in examples hereafter as the myTravelGuide site 50) via either a land line or wireless telephone 20 or through the use of a hand-held device 30. A preferred embodiment for telephone access is a toll-free automated phone system for checking or making modifications to itineraries. Hand-held device 30 has at least one PDA client application 32, such as a WAP-enabled browser, for communicating with server application 52 on the Internet 40.

With further regard to FIG. 1, The myTravelGuide site 50 preferably comprises one or more physical servers that run a myTravelGuide server application 52 to implement the myTravelGuide Service. The site 50 is preferably operated by a single business, or a small collection of businesses, that are qualified to perform secure transactions on behalf of the users.

Although a single myTravelGuide site 50 is shown in FIG. 1, it will be recognized that multiple MyTravelGuide sites could be provided on the Internet 40. For example, myTravelGuide sites may be set up at several different geographical locations to distribute the load and allow for network latency issues in various countries.

The myTravelGuide site 50 includes one or more physical databases for storing various account information with respect to travelers and service providers. The Travel Content Database 54 contains typical information found in travel guides, such as country and city information and information about attractions and activities of interest, including but not limited to descriptions, hours, costs, and photos. The Business Rules and Recommendations Database 56 contains selected programmatic logic behind the system for making suggestions based on user profile, user selections, date and time of travel, as well as any rules and constraints regarding events or activities. For example, a constraint may be that they must start on a Friday or that the duration must be 4 hours. Service Provider Database 58 contains information on details of service providers. For example, this database contains what tours are offered by tour operators, hotel names and locations, or transportation details. Traveler Database 60 contains membership information such as passwords, profiles, preferences, and any associated customized travel guides and customized travel itineraries appropriately linked to the traveler's unique identifier. Traveler Ratings and Suggestion Database 62 contains ratings of service providers given by the travelers as well as any travel suggestions they might have for fellow travelers.

Note that this embodiment does not limit the information that may be contained in these databases, but only defines basic information provided.

Finally, myTravelGuide site 50 may save, and make available to advertisers, certain aggregate marketing information that can be used to tailor their respective services and products.

FIG. 2 illustrates basic steps that take place when a traveler registers at the MyTravelGuide site 50. In block 80, the visitor initially locates the MyTravelGuide Service by obtaining the location information of the corresponding MyTravelGuide site 50. This location information may be in a variety of forms, such as a Uniform Resource Locator (URL), a Domain Name Service (DNS) name, or an Internet Protocol (IP) address. This may also be from search engines, reciprocal links, Emails, or other forms of advertising.

With reference to block 82, if a traveler makes a request to register with the MyTravelGuide system, the system displays 84 the Traveler Registration Form. They then provide 86 profile information. In addition they also provide an associated password and password hint to be used when accessing their profile in the future. The MyTravelGuide system assigns 88 a unique identifier to be used later for identification and authentication and tagging items of interest. Upon the storing 90 of the new traveler profile in the traveler database 60, the MyTravelGuide system sends 92 an e-mail confirmation of the registration to the user.

The profile information contains a customer name and email and may also contain additional information such as user preferences and any customized travel guides and itineraries either completed or in progress.

FIG. 3 shows a process for a traveler to update a profile. They first locate 80 MyTravelGuide Site 50. The traveler then accesses 102 a secured profile. Then, if the traveler chooses 104 to modify a profile, the system checks 106 to see if they are authorized. If they are not authorized, then the system displays 108 an unauthorized warning and completes the process. If they are authorized, then the system displays 110 a pre-populated Traveler Profile form from which the traveler enters 112 the appropriate information and submits the form. At this point, the system checks 114 to see if the form is valid, by checking for required fields, and by checking that the form passes all validation rules. If the information is not complete and correct, the user is shown appropriate error messages and is given another chance to correct the information. Otherwise, if the form is valid, then the system updates 116 the traveler profile in the traveler database 60. The system then displays 118 a Profile Modification Confirmation for the user.

FIG. 4 shows a process for maintaining a traveler's itineraries including adding new itineraries, modifying existing itineraries, deleting existing itineraries, and identifying which itinerary is the current one for adding tagged items to. The process begins by the traveler accessing 102 their secured profile and selecting 120 to view existing itineraries. Next, the myTravelGuide Site 50 displays 122 existing traveler itineraries. At this point, a user can either a) Add a New Itinerary; b) Copy an Existing Itinerary; c) Modify an Existing Itinerary; d) Delete an Existing Itinerary; or e) Change which Itinerary is the current Itinerary. If the traveler selects to add 124 a new itinerary, then the system creates 126 a new itinerary and then displays 128 a Itinerary Property Form. The traveler then enters 130 form information and the system saves 132 the form information in the Traveler Database 60. Examples of information that is on the form includes the Desired Starting Date and the Desired Duration of the trip.

If a traveler selects to modify 136 an existing itinerary, then the system displays 128 an Itinerary Property Form. The traveler then enters 130 form information and the system saves 132 the form information in the Traveler Database 60.

It a traveler selects to delete 138 an existing itinerary, then the system deletes 140 the itinerary from the Traveler Database 60.

If the system determines 142 that the traveler changed their current itinerary, then the system marks 144 the selected itinerary as the current itinerary.

The system continually checks 146 to see if a traveler chooses to exit. If a traveler chooses to exit then the process ends. Otherwise, if a traveler does not chose to exit, then the process continues with step 124.

FIG. 5 shows a process for a traveler to view countries and tag them for inclusion in a customized travel guide and itinerary. They are first shown 150 countries from which they can choose and then select 152 a country on the myTravelGuide Site 50. This may be done via selection from a list of countries, selection on a geographical map, or through a hyperlink with the country name. Other embodiments contemplated are selection through speech recognition, kiosks or links from other web sites, to name a few. The myTravelGuide Site 50 then displays 154 country information with the country tagged if it was previously tagged.

At this point, a check is made 156 to see if the traveler has changed the tagging of the country. If the country tag has changed, then the system checks 158 to see if the country is currently tagged. If the country is currently tagged, then the system tags 160 the current country for inclusion in their customized travel guide and itinerary. If the country is not currently tagged, then the system un-tags 162 the current country to remove it from the traveler's customized travel guide and itinerary. Note that the system optimally presents a confirmation warning as this removes all cities, activities or attractions associated with that country.

If a traveler chooses to view 164 another country, then the system displays 152 countries again and the process starts over with a new country.

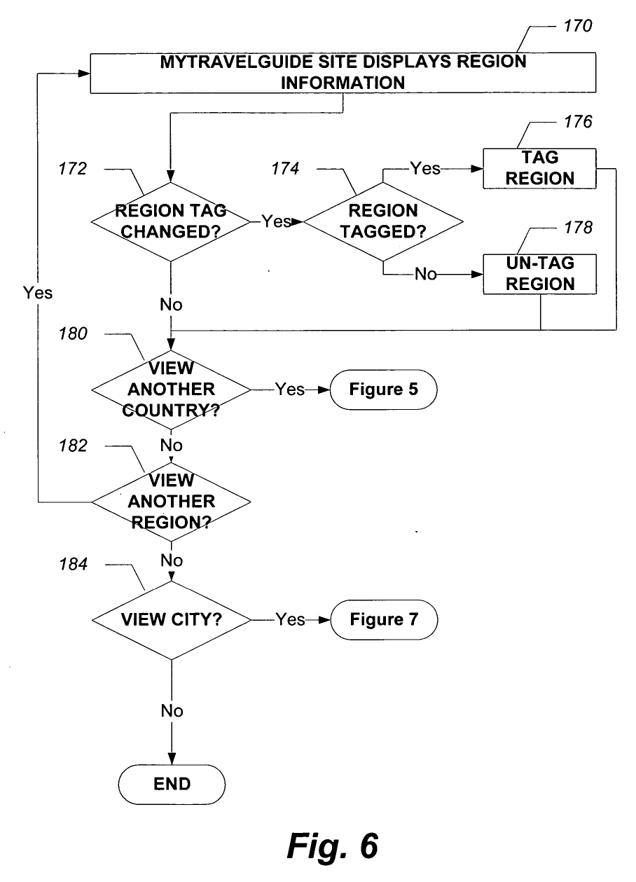

If a traveler chooses to view 166 a region of that country, then the process continues with FIG. 6.

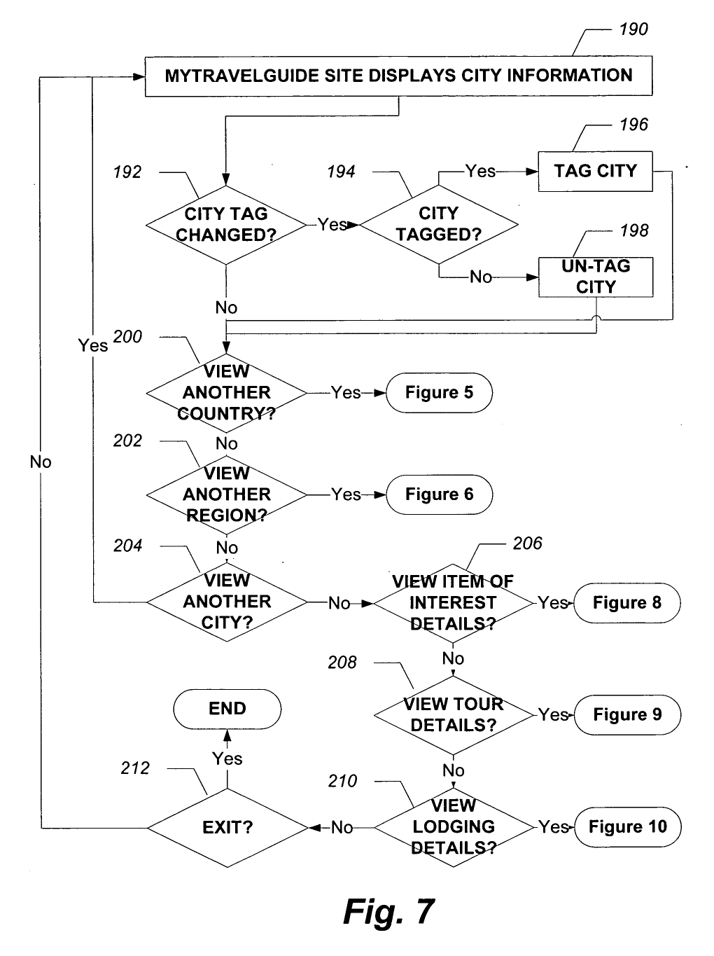

If a traveler chooses to view 168 a city of that country, then the process continues with FIG. 7.

FIG. 6 shows a process for a traveler to view regions and tag them for inclusion in a customized travel guide and itinerary. The myTravelGuide Site 50 begins by displaying 170 region information with the region tagged if it was previously tagged.

At this point, a check is made 172 to see if the traveler has changed tagging of the region. If the region tag has changed, then the system checks 174 to see if the region is currently tagged. If the region is currently tagged, then the system tags 176 the current region for inclusion in their customized travel guide and itinerary. Note that this automatically selects the corresponding country for inclusion. If the region is not currently tagged, then the system un-tags 178 the current region to remove it from the traveler's customized travel guide and itinerary. Note that the system optimally presents a confirmation warning as this removes all cities, activities or attractions associated with that region.

If a traveler chooses to view 180 another country, then the process continues with FIG. 5.

If a traveler chooses to view 182 another region, then the system displays 170 selected region information and the process starts over with the new region.

If a traveler chooses to view 184 a city of that region, then the process continues with FIG. 7.

FIG. 7 shows a process for a traveler to view cities and tag them for inclusion in their customized travel guide and itinerary. The myTravelGuide Site 50 begins by displaying 190 the city information with the city tagged if it was previously tagged.

At this point, a check is made 192 to see if the traveler has changed the tagging of the city. If the city tag has changed, then the system checks 194 to see if the city is currently tagged. If the city is currently tagged, then the system tags 196 the current city for inclusion in their customized travel guide and itinerary. Note that this automatically selects the corresponding country and region for inclusion. If the city is not currently tagged, then the system un-tags 198 the current city to remove it from the traveler's customized travel guide and itinerary. Note that the system optimally presents a confirmation warning as this removes all activities or attractions associated with that city.

If a traveler chooses to view 200 another country, then the process continues with FIG. 5.

If a traveler chooses to view 202 another region, then the process continues with FIG. 6.

If a traveler chooses to view 204 another city, then the system displays 190 the selected city information and the process starts over with the new city.

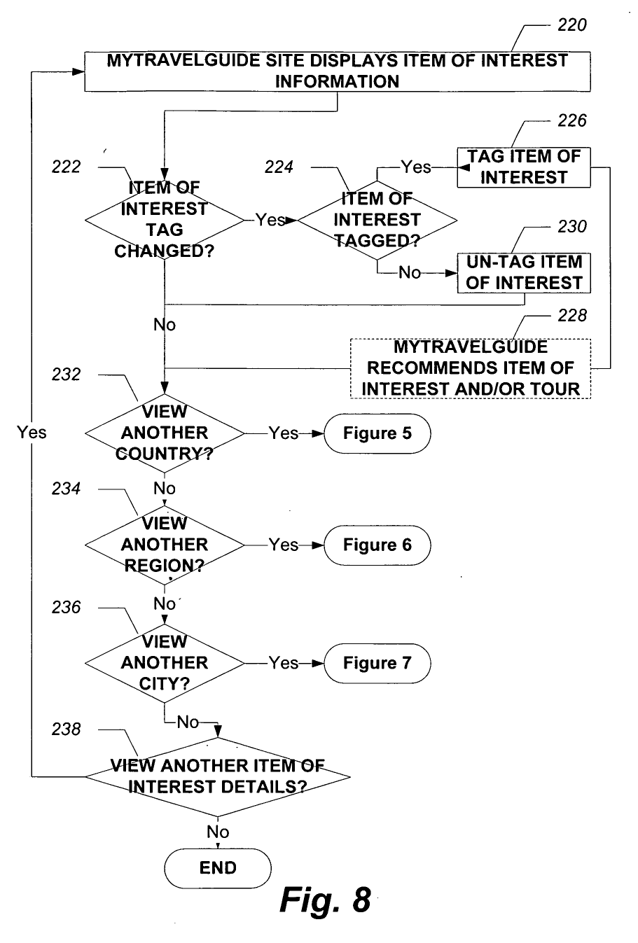

If a traveler chooses to view 206 an item of interest, then the process continues with FIG. 8.

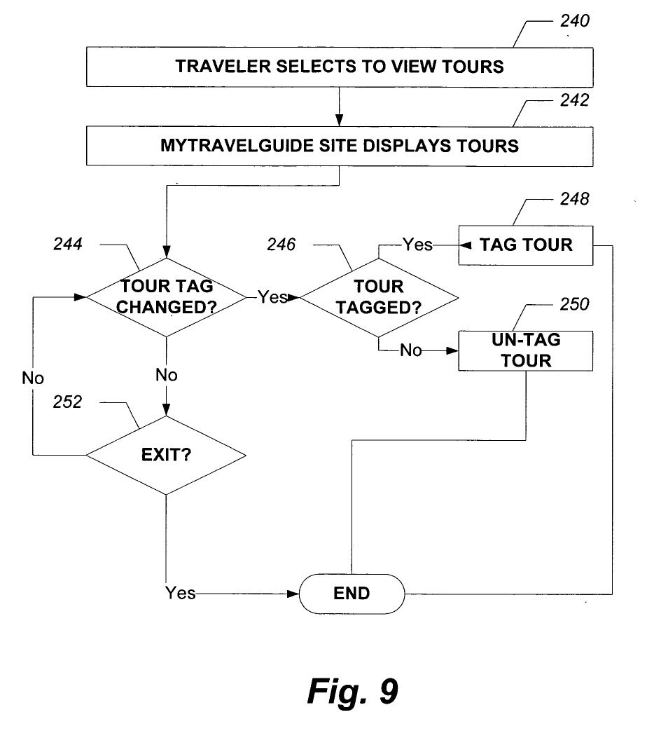

If a traveler chooses to view 208 a tour, then the process continues with FIG. 9.

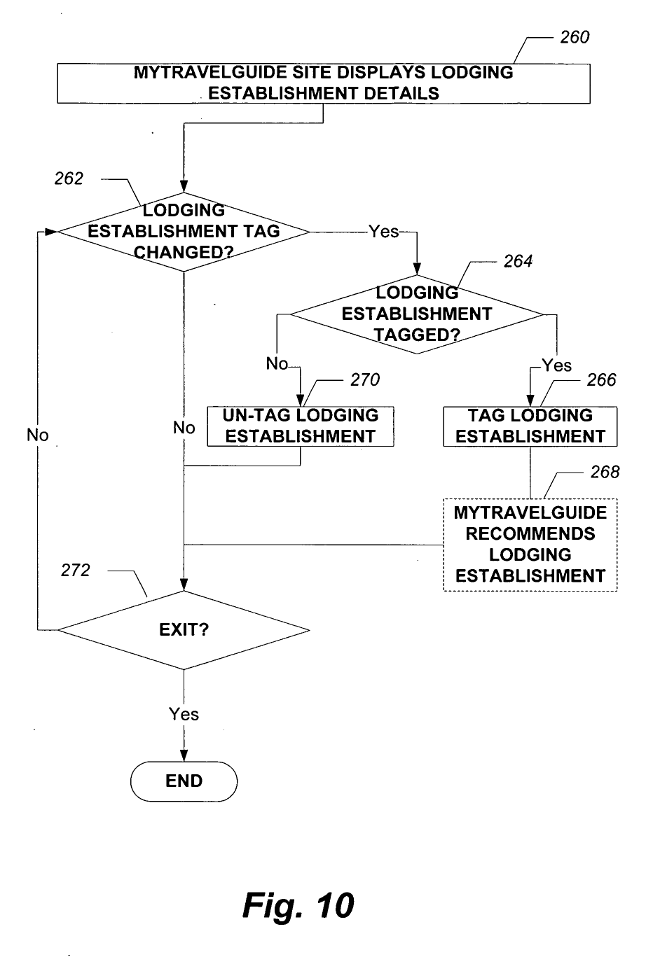

If a traveler chooses to view 210 a lodging establishment, then the process continues with FIG. 10.

If a traveler chooses to exit 212, then the process ends. Otherwise, it start over again at step 190.

FIG. 8 shows a process for a traveler to view items of interest and tag them for inclusion in their customized travel guide and itinerary. These items of interest may include lodging establishments, dining establishments, activities or attractions. In addition, the term “items of interest” may refer to attractions or activities that are not located within city limits. The myTravelGuide Site 50 begins by displaying 220 item of interest information with an item of interest tagged if it was previously tagged.

At this point, a check is made 222 to see if the traveler has changed tagging of an item of interest. If an item of interest tag has changed, then the system checks 224 to see if the item of interest is currently tagged. If the item of interest is currently tagged, then the system tags 226 the current item of interest for inclusion in their customized travel guide and itinerary. Note that this automatically selects the corresponding country and region for inclusion, and city if appropriate. The myTravelWeb Site 50 advantageously recommends 228 other items of interest or tours based on user selections and profiles of similar travelers. If an item of interest is not currently tagged, then the system un-tags 230 the current item of interest to remove it from the traveler's customized travel guide and itinerary. Note that the system optimally presents a confirmation warning.

If a traveler chooses to view 232 another country, then the process continues with FIG. 5.

If a traveler chooses to view 234 another region, then the process continues with FIG. 6.

If a traveler chooses to view 236 another city, then the process continues with FIG. 7.

If a traveler chooses to view 238 another item of interest, then the system displays 220 the selected item of interest information and the process starts over with the new item of interest.

FIG. 9 shows a process for a traveler to view tours of interest and tag them for inclusion in their customized travel guide and itinerary. These tours may include tours of any length, half-day, full-day, or multi-day tours. Tours may be offered by multiple tour operators. The process begins by the traveler selecting 240 to view tours. The system advantageously presents them with a choice of a) all tours; b) only related tours (based on locations selected); or c) recommended tours (based on locations and items of interest selected). The myTravelGuide Site 50 then displays 242 tours with the tours tagged if they were previously tagged.

At this point, a check is made 244 to see if the traveler has changed tagging of a tour. If a tour tag has changed, then the system checks 246 to see if the tour is currently tagged. If the tour is currently tagged, then the system tags 248 the current tour for inclusion in their customized travel guide and itinerary. Note that this automatically selects the corresponding country, region, and items of interest for inclusion, and city if appropriate. If a tour is not currently tagged, then the system un-tags 250 the current tour to remove it from the traveler's customized travel guide and itinerary. Note that the system optimally presents a confirmation warning asking if the related items of interest should also be removed or keep the items of interest tagged but remove the corresponding tour.

The system continually checks for the changing of tour tags until the traveler chooses 252 to exit. If another tour tag is changed, the process continues with item 244.

FIG. 10 shows a process for a traveler to view lodging establishments and tag them for inclusion in their customized travel guide and itinerary. The myTravelGuide Site 50 begins by displaying 260 lodging establishment information with a lodging establishment tagged if it was previously tagged.

At this point, a check is made 262 to see if the traveler has changed tagging of the lodging establishment. If the lodging establishment tag has changed, then the system checks 264 to see if the lodging establishment is currently tagged. If the lodging establishment is currently tagged, then the system tags 266 the current lodging establishment for inclusion in their customized travel guide and itinerary. Note that this automatically selects the corresponding country and region for inclusion, and city if appropriate. The myTravelWeb Site 50 optionally recommends 268 other lodging establishments based on user selections, and profiles of similar travelers. If the lodging establishment is not currently tagged, then the system un-tags 270 the current lodging establishment to remove it from the traveler's customized travel guide and itinerary. Note that the system optimally presents a confirmation warning.

The system continually checks for the changing of lodging establishment tags until the traveler chooses 272 to exit. If another lodging establishment tag is changed, the process continues with item 262.

FIG. 11 shows a process for a traveler defining how an itinerary is to be created, viewed and edited. The Traveler begins by choosing 280 to define how their itinerary will be built and viewed. They are then provided the choices of a) Build Day Segments (such as half day chunks); b) Build Trip Day; c) Order Trip Days; or d) Define Trip Location Transportation Segments. In preferred embodiments, an Itinerary is composed of 1 or more Trip Days and each Trip Day is composed of 2 Day Segments. Therefore, in a preferred embodiment, the system does not allow them to chose an option that has no components available for it. For example, the system prevents the traveler from building Trip Days until there are Day Segments to assign to those Trip Days.

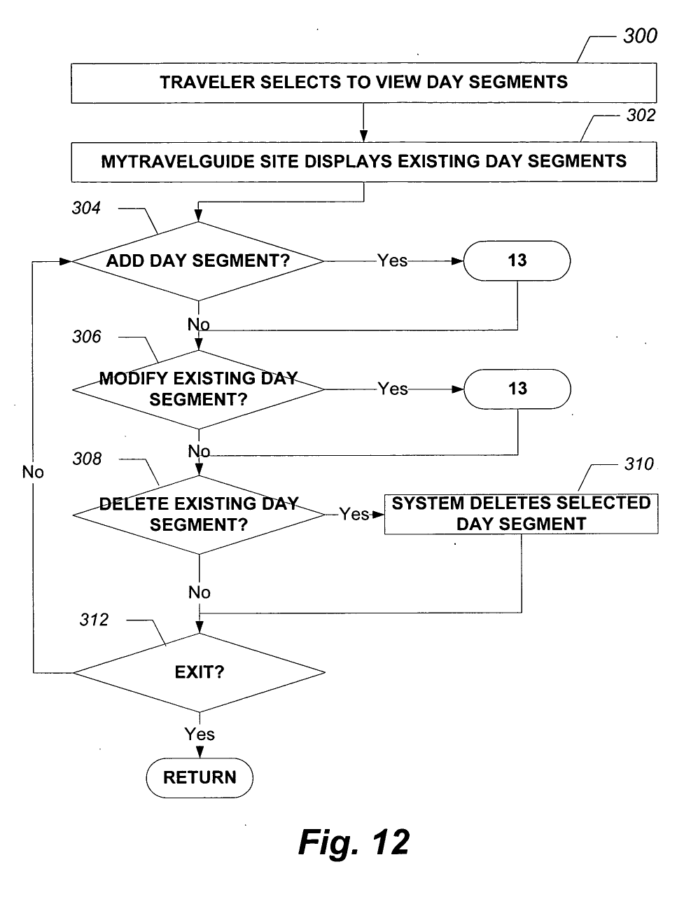

If a traveler chooses 282 Build Day Segments, then the process continues with FIG. 12.

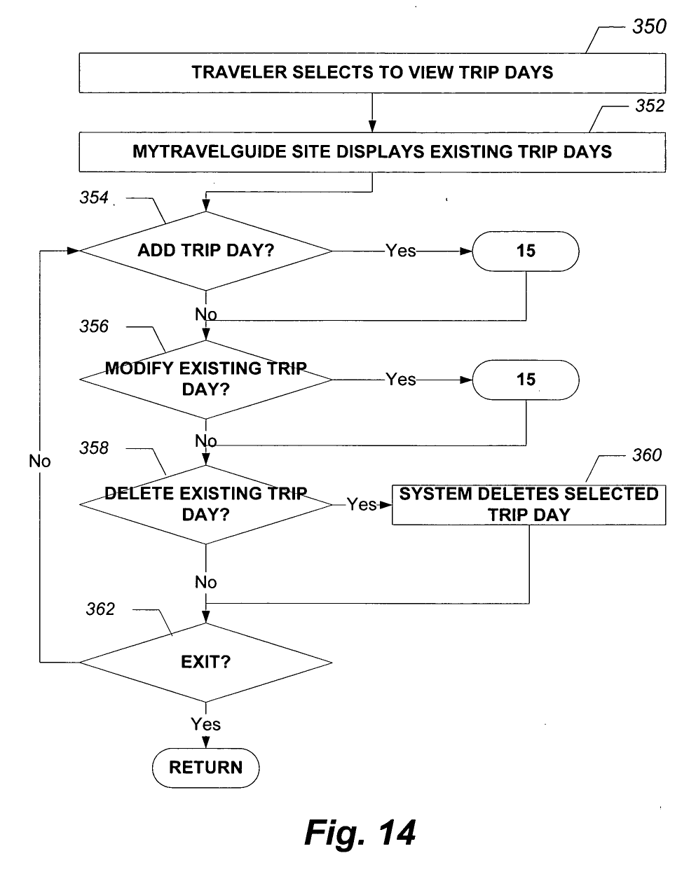

If a traveler chooses 284 Build Trip Day, then the process continues with FIG. 14.

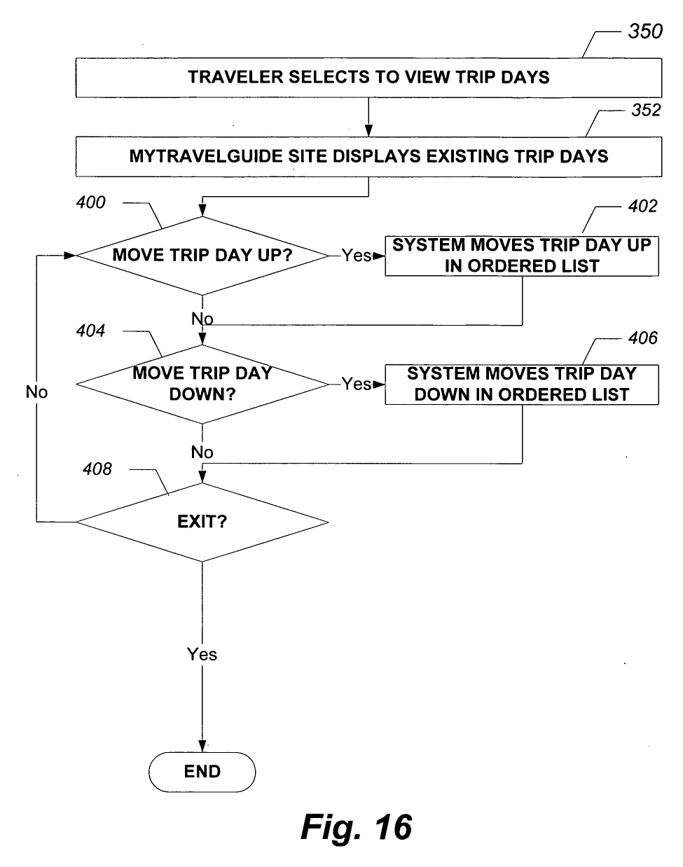

If a traveler chooses 286 Order Trip Days, then the process continues with FIG. 16.

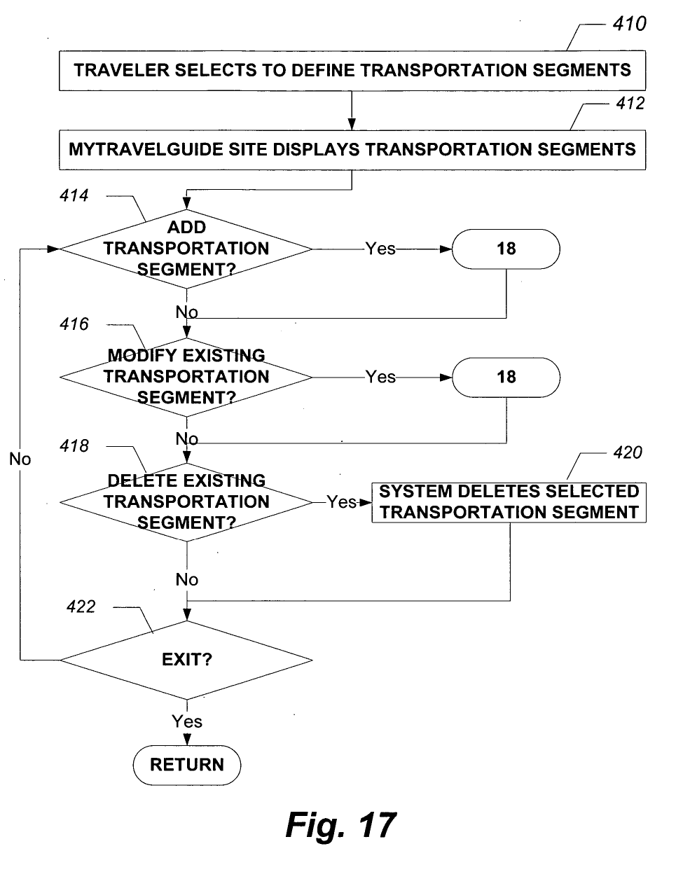

If a traveler chooses 288 Define Trip Location Transportation Segments, then the process continues with FIG. 17.

If a traveler chooses 290 to exit, then the process ends. Otherwise, the process repeats itself by returning to step 280.

FIG. 12 shows a process of building Day Segments from Items of Interest previously selected. This process begins by the traveler selecting 300 to view the Day Segments. The myTravelGuide Site 50 then displays 302 existing Day Segments and the user is then able to make a choice of a) Add Day Segment; b) Modify Existing Day Segment; or c) Delete Existing Day Segment. The list of Day Segments may optionally contain other information such as status (e.g. Partial or Complete).

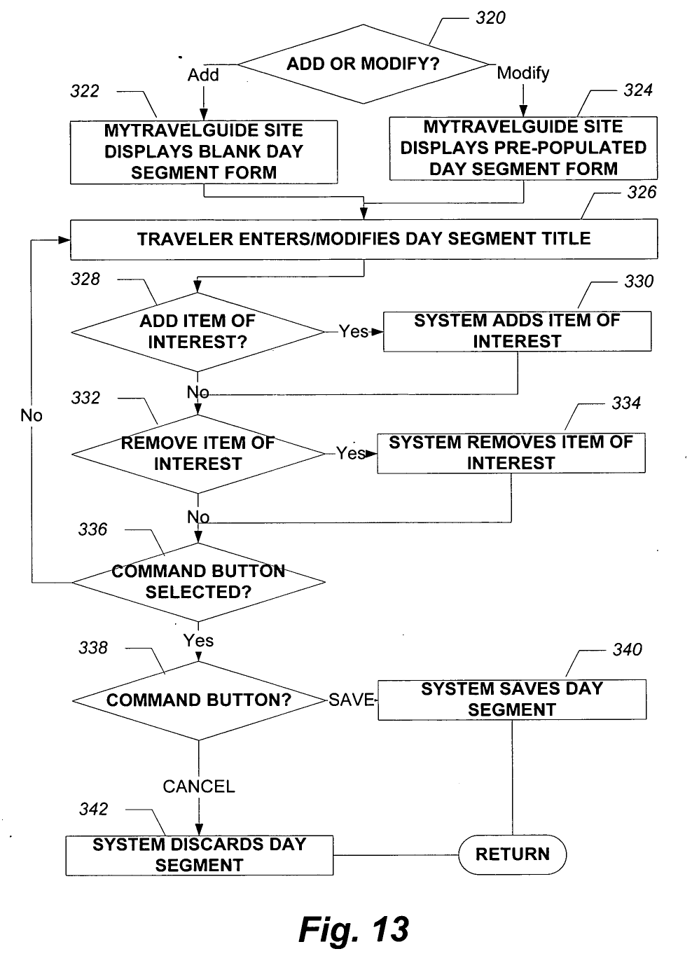

If a traveler chooses 304 to add Day Segment, then the process continues with FIG. 13.

If a traveler chooses 306 to Modify Existing Day Segment, then the process continues with FIG. 13.

If a traveler chooses 308 to Delete Existing Day Segment, then the system deletes 310 the selected Day Segment. Note that the system optimally presents a confirmation warning.

If a traveler chooses 312 to exit, then the sub-process ends and returns to the calling process. Otherwise, the sub-process continues with step 302.

FIG. 13 shows a process of adding a new or modifying an existing Day Segment. This process begins by myTravelGuide Site 50 determining 320 whether the traveler is adding a new Day Segment or modifying an existing Day Segment. If the traveler is adding a new Day Segment, then the myTravelGuide Site 50 displays 322 a blank Day Segment Form. Otherwise, if the traveler is modifying an existing Day Segment, then the myTravelGuide Site 50 displays 324 a pre-populated day segment form. The day segment form allows the traveler to add and remove Items of Interest which have not already been assigned to other Day Segments. Optionally a list of available Items of Interest may be filtered for relevant items based on criteria such as nearby currently selected items of interest. Next the traveler is provided an opportunity to enter or modify 326 a Day Segment Title, which is used to more easily identify the chunk for assigning to Trip Days later in the process. Next, the traveler may choose to add or remove items of interest in any order that they like.

If a traveler chooses 328 to add an item of interest, then the system adds 330 that item of interest to their current Day Segment being defined. Optionally, the system prevents new items being added to the current Day Segment if an allotted number of hours from previous selections is full. Alternatively, the system may provide a warning.

If a traveler chooses 332 to remove an item of interest, then the system removes 334 that item of interest from the current Day Segment being defined.

If the system determines 336 that a command button is pressed, then the system next determines 338 which command button was selected and branches depending upon whether the traveler choose a Save or a Cancel command button. If the Save command button was selected, then the system saves 340 the current Day Segment with the current itinerary. Otherwise, if the Cancel command button was selected, then the system discards 342 the current Day Segment. Either way, the process returns to the calling process.

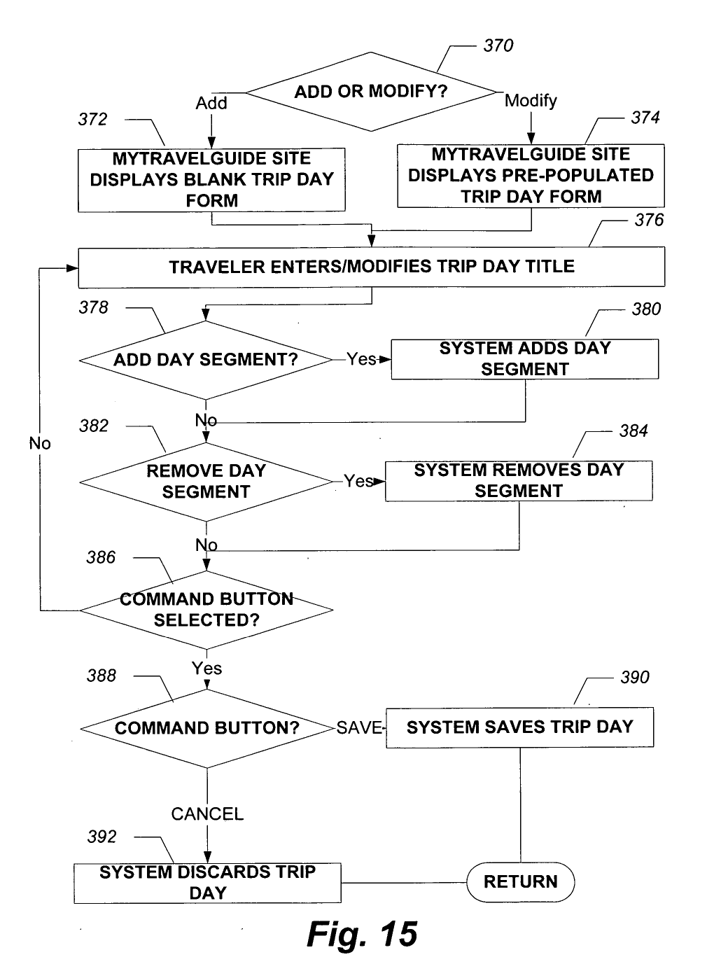

FIG. 14 shows a process of building Trip Days from Day Segments previously created. This process begins by a traveler selecting 350 to view Trip Days. The myTravelGuide Site 50 then displays 352 existing Trip Days and a user is then able to make a choice of a) Add Trip Day; b) Modify Existing Trip Day; or c) Delete Existing Trip Day. The list of Trip Days may optionally contain other information such as status (e.g. Partial, Complete, Pending Reservation, or Confirmed). If a traveler chooses 354 to add Trip Day, then the process continues with FIG. 15.

If a traveler chooses 356 to Modify Existing Trip Day, then the process continues with FIG. 15.

If a traveler chooses 358 to Delete Existing Trip Day, then the system deletes 360 selected Trip Day. Note that the system optimally presents a confirmation warning.

If a traveler chooses 362 to exit, then the sub-process ends and returns to the calling process. Otherwise, the sub-process continues with step 354.

FIG. 15 shows a process of adding a new or modifying an existing trip day. This process begins by myTravelGuide Site 50 determining 370 whether a traveler is adding a new trip day or modifying an existing trip day. If the traveler is adding a new trip day, then myTravelGuide Site 50 displays 372 a blank Trip Day Form. Otherwise, if a traveler is modifying an existing trip day, then myTravelGuide Site 50 displays 374 a pre-populated Trip Day Form. The Trip Day Form allows a traveler to add and remove Day Segments which have already been created. Next a traveler is provided an opportunity to enter or modify 376 a Trip Day Title, which is used to more easily identify the trip day for ordering later in the process. Next, a traveler may choose to add or remove Day Segments in any order that they like.

If a traveler chooses 378 to add a Day Segment, then the system adds 380 that Day Segment to their current Trip Day being defined. Optionally, the system prevents more time than can be fit into a day, such as more than two half Day Segments, from being added to a single Trip Day. Alternatively, the system may provide a warning. Another embodiment may prevent half-day segments that are designated as morning-only or afternoon-only being assigned to an opposite Day Segment.

If a traveler chooses 382 to remove a Day Segment, then the system removes 384 that Day Segment from the current Trip Day being defined.

If the system determines 386 that a command button is pressed, then the system next determines 388 which command button was selected and branches depending upon whether a traveler choose a Save or a Cancel command button. If a Save command button was selected, then the system saves 390 the current Trip Day with the current itinerary. Otherwise, if a Cancel command button was selected, then the system discards 392 the current Trip Day. Either way, the process returns to the calling process.

FIG. 16 shows a process of ordering Trip Days. The process begins by a traveler selecting 350 to view trip days. Next, myTravelGuide Site 50 displays 352 existing trip days. At this point, a traveler may either a) Move a Trip Day up; or b) Move a Trip Day down. If they choose 400 to move a Trip Day up, then the system moves 402 the trip day up in an ordered list. Otherwise, if the traveler chooses 404 to move a Trip Day down, then the system moves 406 the trip day down in an ordered list.

If a traveler chooses to exit, then the process ends. Otherwise, the process continues at step 400.

FIG. 17 shows a process of defining transportation segments between major locations. This process begins by a traveler selecting 410 to view transportation segments. MyTravelGuide Site 50 then displays 412 existing transportation segments and the user is able to make a choice of a) Add Transportation Segment; b) Modify Existing Transportation Segment; or c) Delete Existing Transportation Segment. The list of Transportation Segments may optionally contain other information such as status (e.g. Partial, Complete, Pending Reservation, or Confirmed).

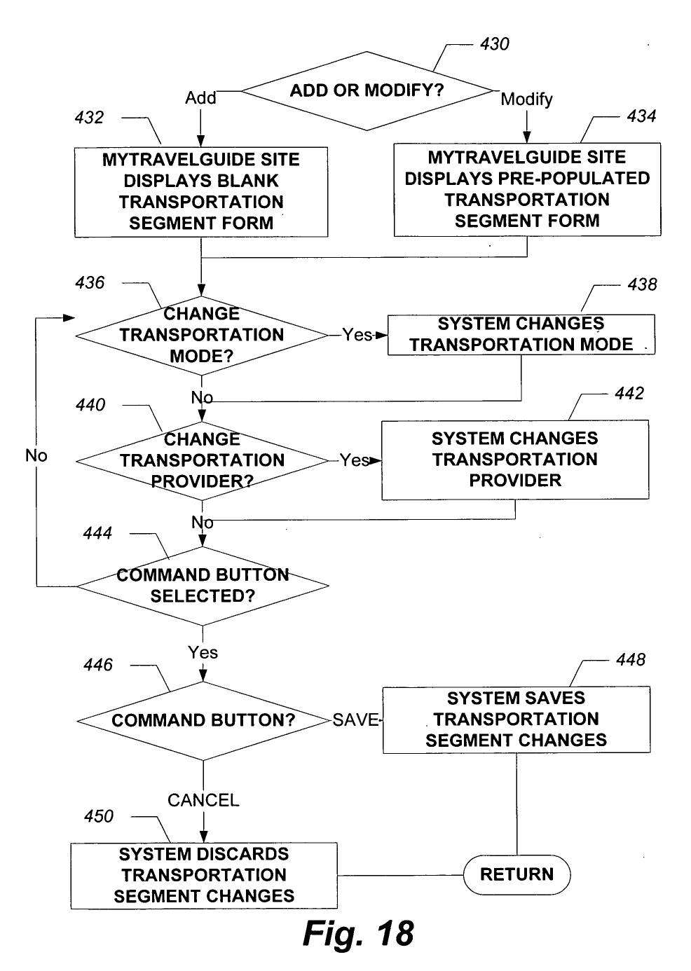

If a traveler chooses 414 to add Transportation Segment, then the process continues with FIG. 18.

If a traveler chooses 416 to Modify Existing Transportation Segment, then the process continues with FIG. 18.

If a traveler chooses 418 to Delete Existing Transportation Segment, then the system deletes 420 the selected Transportation. Note that the system optimally presents a confirmation warning.

If a traveler chooses 422 to exit, then the sub-process ends and returns to the calling process. Otherwise, the sub-process continues with step 414.

FIG. 18 shows a process of adding a new or modifying an existing transportation segment. This process begins by myTravelGuide Site 50 determining 430 whether a traveler is adding a new transportation segment or modifying an existing transportation segment. If a traveler is adding a new transportation segment, then myTravelGuide Site 50 displays 432 a blank Transportation Segment Form. Otherwise, if a traveler is modifying an existing trip day, then myTravelGuide Site 50 displays 434 a pre-populated Transportation Segment Form. The Transportation Segment Form assists a traveler in making sure they are able to transfer between major base cities. Next, a traveler may choose to either change a transportation mode or change a transportation provider. Note that changing of a transportation mode may invalidate a transportation provider.

If a traveler chooses 436 to change a transportation mode, then the system changes 438 the transportation mode. Otherwise, if a traveler chooses 440 to change a transportation provider, then the system changes 442 the transportation provider.

If the system determines 444 that a command button is pressed, then the system next determines 446 which command button was selected and branches depending upon whether the traveler choose a Save or a Cancel command button. If a Save command button was selected, then the system saves 448 the current Transportation Segment with the current itinerary. Otherwise, if a Cancel command button was selected, then the system discards 450 the current Transportation Segment. Either way, the process returns to the calling process.

FIG. 19 shows a process of generating the customized travel guide and itinerary. The process begins with a traveler choosing 460 to generate a customized travel guide and itinerary. Next, optionally, a traveler may customize 462 a layout style. This may be the system providing choices of layouts or a traveler deciding on fonts and font sizes for example. In addition, the system may optionally check 464 if all required information is specified for a complete itinerary and optionally the system may provide 466 a Missing Information Warning and end the process. Alternatively, the system may continue with no check and warning and generate 468 a cover page, then generate 470 a Table of Contents, then generate 472 a customized itinerary, then generate 474 supporting travel details, and then optionally generate 476 travel recommendations. The process completes by the system storing 480 a completed customized travel guide and itinerary. Note that this storage may be either allowing a traveler to retrieve it later via a link in a confirmation email or stored with their online profile.

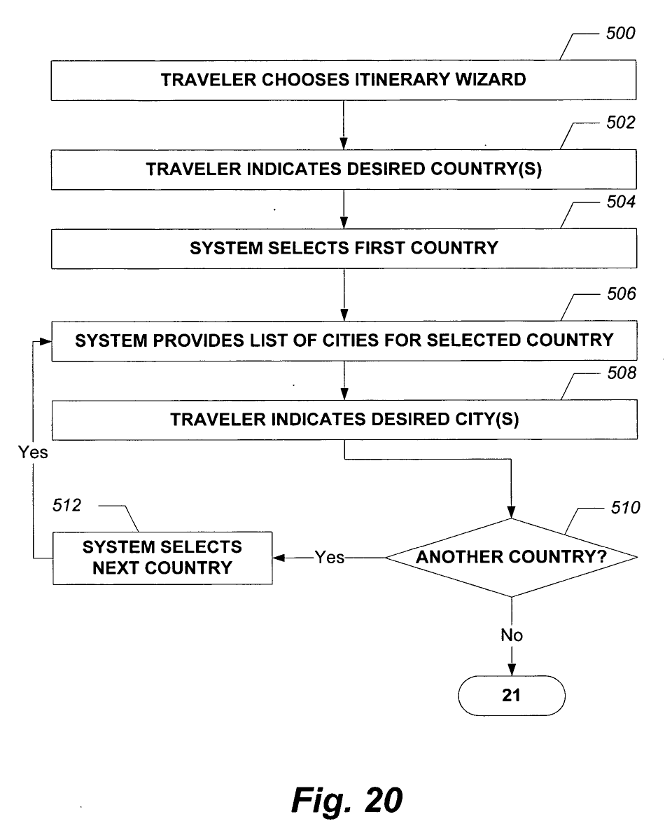

FIG. 20 shows a process whereby a wizard-like automation process may optionally assist a traveler in creating their customized travel guide and itinerary. This wizard runs thru a very similar process as a manual process by first defining “What”, then “How”, and finally generating a compiled customized travel guide and itinerary. The process allows a user to back up to previous steps and return to the process where left off at a later date.

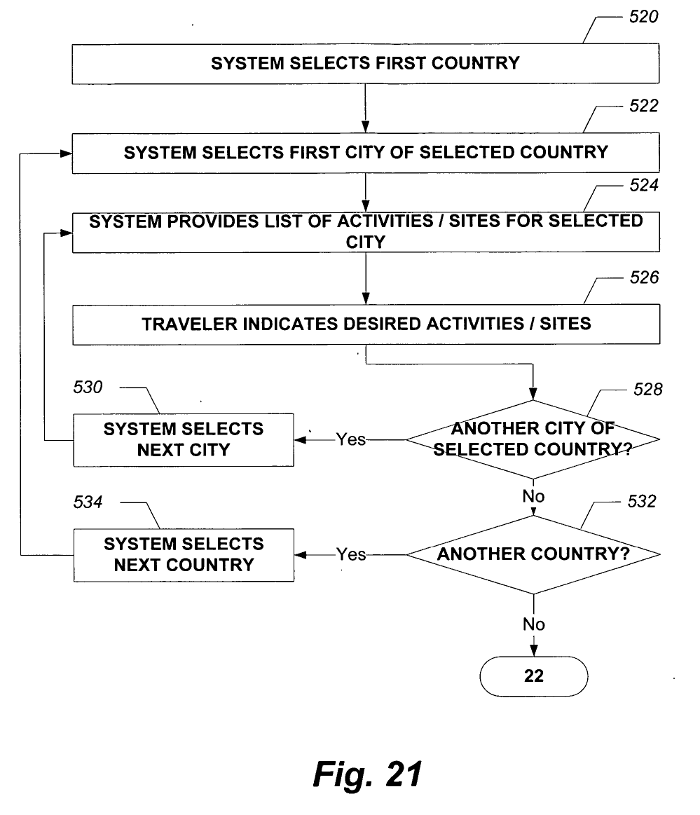

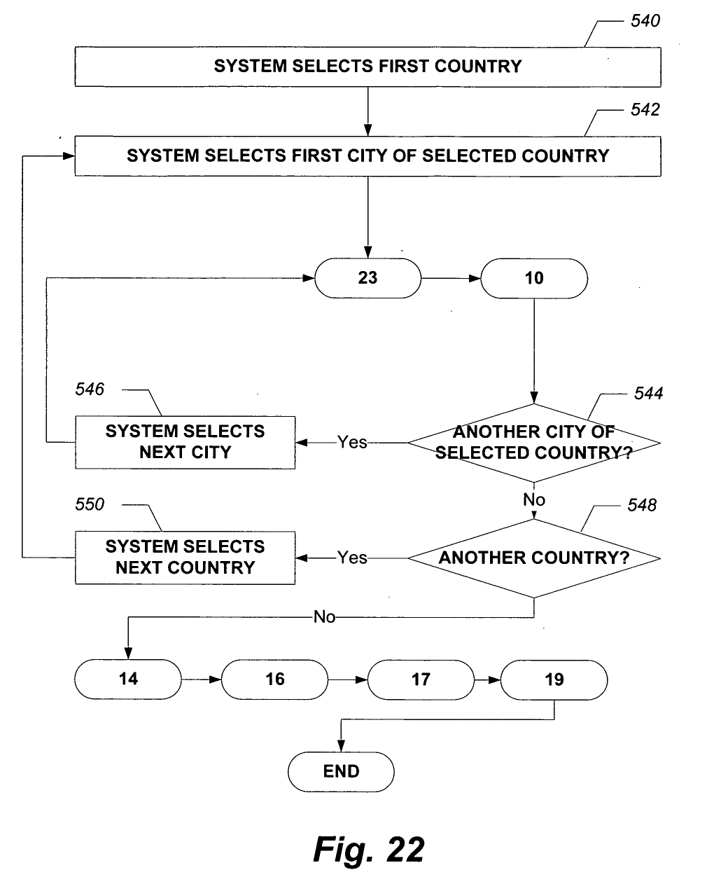

FIG. 21 shows a process whereby a wizard-like automation process may optionally assist a traveler in selecting activities or attractions for each desired city. As mentioned earlier, a wizard may be started at any point in the process with a work-in-progress saved for later completion. This process begins with the system selecting 520 a first country and then selecting 522 a first city of the selected country. Next, the system provides 524 a list of activities or attractions for the selected city. Then, a traveler indicates 526 desired activities or attractions. Then the system determines 528 if there is another city of a selected country. If there is another city of a selected country, then the system selects 530 a next city and starts the process again at step 524. Otherwise, if there is not another city for the selected country, then the system determines 532 if there is another country. If there is another country, then the system selects 534 a next country and starts the process again at step 522. Otherwise, the processes for defining the “What” of the itinerary is completed and a wizard starts to define a “How” with FIG. 22.

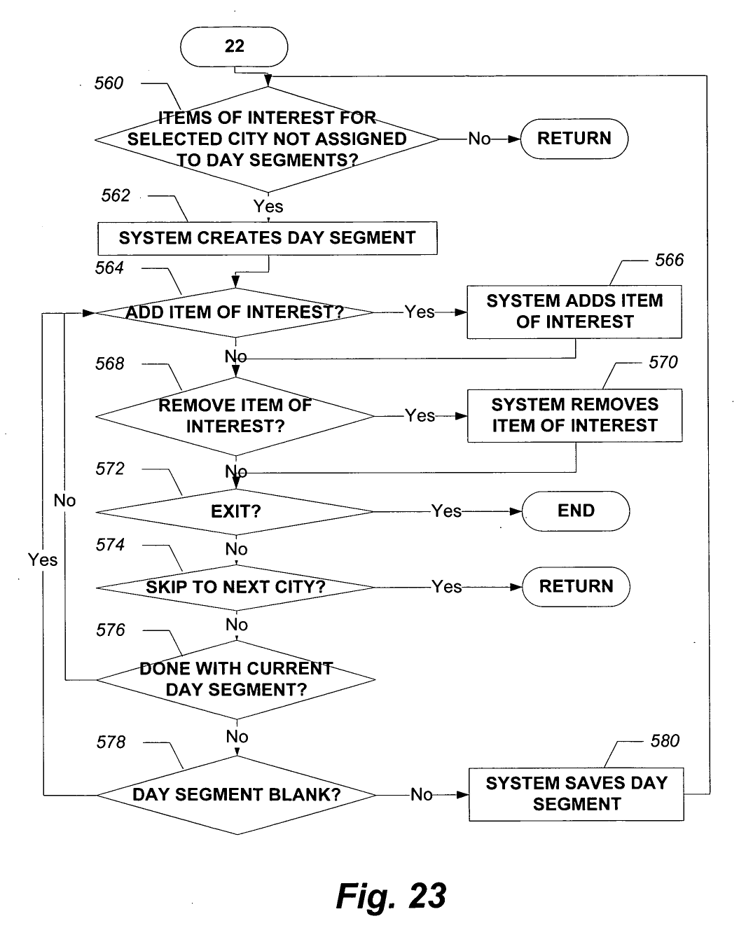

FIG. 22 shows a process of looping through selected countries and cities and then branching to FIG. 23 for each city to create Day Segments containing Items of Interest. This process begins with the system selecting 540 a first country, and then the system selecting 542 a first city of that selected country. From here, the process branches to FIG. 23 to process an individual city and then returns to this process. Upon returning to this process, the system then branches to FIG. 10 to define a Lodging Establishment for the selected city. After returning from FIG. 10, the system determines 544 with there is another city of a selected country. If there is another city of a selected country, then the system selects 546 a next city and repeats the process by branching to FIG. 23. Otherwise, if there are no more cities to be processed for a selected country, then the system next determines 548 if there are any more countries to process. If there are more countries, then the system selects 550 the next country and repeats the process by branching to step 542. Otherwise, if there are no more countries to be processed, then the wizard continues to FIG. 14 to define Trip Days, then FIG. 16 to order the Trip Days, then FIG. 17 to define Transportation Segments, and finally FIG. 19 to generate an assembled customized travel guide and itinerary.

FIG. 23 shows a process of adding and removing Items of Interest to Day Segments which are assigned to cities. The process begins by the system determining 560 if there are any Items of Interest for a selected city that have not been assigned to Day Segments yet. If there are no Items of Interest left to be assigned, then the process returns to the calling process. Otherwise, if there are still Items of Interest left to be assigned, then the system creates 562 a Day Segment. At this point, a traveler has the choice of a) Adding an Item of Interest; b) Removing an Item of Interest; c) Completing the Half-Day Segment; d) Skipping to Next City; or e) Exiting the Wizard Process.

If a traveler chooses 564 to add an Item of Interest, then the system adds 566 the Item of Interest.

If a traveler chooses 568 to remove an Item of Interest, then the system removes 570 the Item of Interest.

If a traveler chooses 572 to exit, then the process ends.

If a traveler chooses 574 to skip to the next city, then the process returns to the calling process.

If a traveler chooses 576 that they are done with the current Day Segment, then the system checks 578 to see if the Day Segment is blank. If the Day Segment is not blank, then the system saves 580 the Day Segment with the current itinerary and starts the process over at step 560. If the Day Segment is blank, then the process branches to step 564. In an alternative embodiment, a traveler is not allowed to select the option of being done with a current Day Segment if it is currently blank, although they always have the option of skipping to a next city or exiting a wizard.

FIGS. 24-26 show a process of Viewing, Tagging, Rating, and Providing Recommendations on Locations, Service Providers (e.g. Lodging Establishments, Tour Operators), Activities and Attractions. In a preferred system travelers may provide a rating of these travel items to be used later in a generation of theirs and other's itineraries and guides. Optimally, each travel item it rated individually. One museum may be rated very high, another low, while another not rated at all.

FIG. 24 begins by a traveler choosing 590 to view details on a location. The system, then displays 592 location details. At this point, a traveler has a choice, in any order, of the following options a) Rate a Location; b) Provide a Location Recommendation; c) Tag/Untag a Location for their Itinerary; or d) exit and return to the calling procedure.

If a traveler chooses 594 to rate a Location, then the system displays 596 the Location Rating Form, from which the traveler enters 598 a Location Rating.

If a traveler chooses 600 to provide a Location Recommendation, then the system displays 602 a Location Recommendation Form, from which the traveler enters 604 a Location Recommendation.

If the system determines 606 that a traveler has changed a tagging of a location, then the system next determines 608 whether the location is currently tagged or not. If a location is not currently tagged, then the system removes 610 the location from the itinerary. Otherwise, if a location is currently tagged, then the system adds 612 the location to the itinerary.

If the system determines 614 that a traveler would like to exit the process, then the process returns to the calling process. Otherwise, the process branches to step 592.

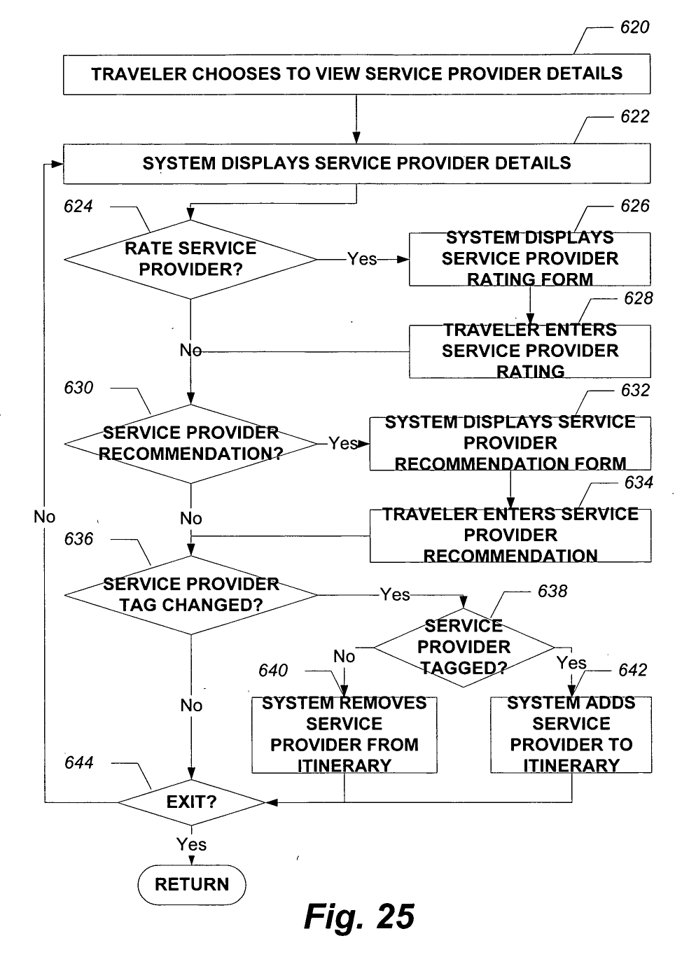

FIG. 25 begins by a traveler choosing 620 to view details on a Service Provider. The system, then displays 622 Service Provider details. At this point, a traveler has a choice, in any order, of the following options a) Rate a Service Provider; b) Provide a Service Provider Recommendation; c) Tag/Untag a Service Provider for their Itinerary; or d) exit and return to the calling procedure.

If a traveler chooses 624 to rate a Service Provider, then the system displays 626 a Service Provider Rating Form, from which a traveler enters 628 a Service Provider Rating.

If a traveler chooses 630 to provide a Service Provider Recommendation, then the system displays 632 a Service Provider Recommendation Form, from which a traveler enters 634 a Service Provider Recommendation.

If the system determines 636 that a traveler has changed a tagging of a Service Provider, then the system next determines 638 whether the Service Provider is currently tagged or not. If a Service Provider is not currently tagged, then the system removes 640 the Service Provider from the itinerary. Otherwise, if the location is currently tagged, then the system adds 642 the Service Provider to the itinerary.

If the system determines 644 that a traveler would like to exit the process, then the process returns to the calling process. Otherwise, the process branches to step 622.

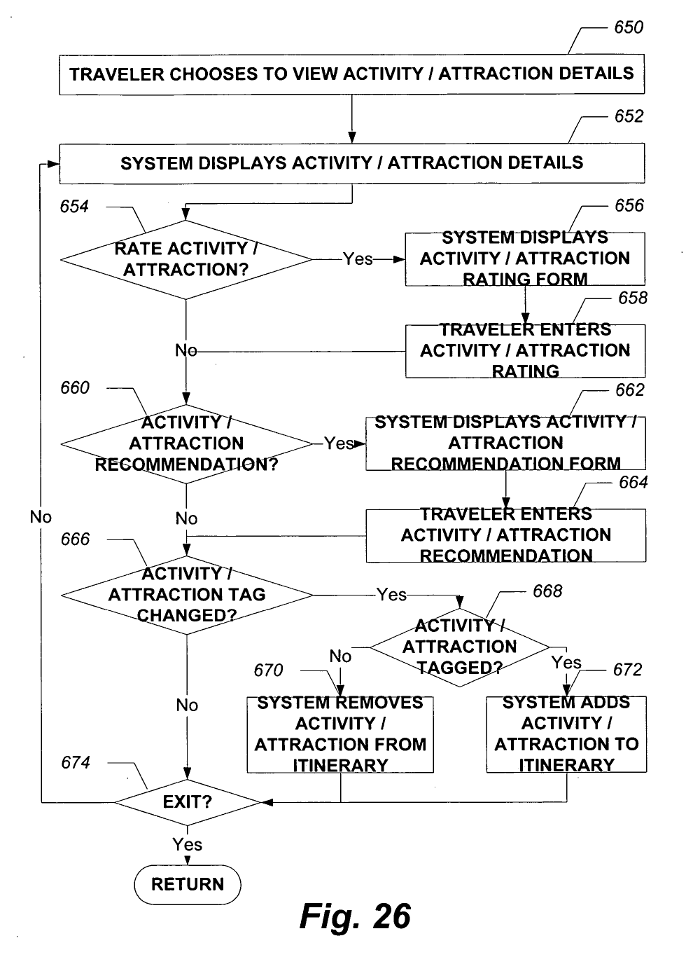

FIG. 26 begins by a traveler choosing 650 to view details on an Activity or attraction. The system, then displays 652 an Activity or attraction details. At this point, a traveler has a choice, in any order, of the following options a) Rate an Activity or Attraction; b) Provide a Activity or Attraction Recommendation; c) Tag/Untag an Activity or Attraction for their Itinerary; or d) exit and return to the calling procedure.

If a traveler chooses 654 to rate an activity or attraction, then the system displays 656 an Activity or Attraction Rating Form, from which a traveler enters 658 an Activity or Attraction Rating.

If a traveler chooses 660 to provide an Activity or Attraction Recommendation, then the system displays 662 an Activity or Attraction Recommendation Form, from which a traveler enters, 664 an Activity or Attraction Recommendation.

If the system determines 666 that a traveler has changed a tagging of an activity or attraction, then the system next determines 668 whether the activity or attraction is currently tagged or not. If an activity or attraction is not currently tagged, then the system removes 670 the activity or attraction from the itinerary. Otherwise, if a location is currently tagged, then the system adds 672 the activity or attraction to the itinerary.

If the system determines 674 that a traveler would like to exit the process, then the process returns to the calling process. Otherwise, the process branches to step 652.

FIGS. 27-33 diagram basic database tables necessary to store and maintain content required for a preferred embodiment of this disclosure. Content may be acquired through the distributed network or by manual data entry. Some or all of the content may be maintained by a centralized site, while other content may be continuously updated and maintained by service providers, such as tour operators, tourist offices, transportation companies, lodging establishments and restaurant owners. Information may be exchanged through shared software applications running on multiple computing devices, such software distributed through partnerships with travel service providers, or information may be gathered by programmatic devices well known in the art, such as web crawlers, spider's and data miners, or any device for information gathering now known or later developed.

FIG. 27 describes database tables of an “Activity” subject area. These tables consist of a Point of Interest Type Table 680 and a Activity Type Table 686, which are merely lookup tables and rarely change. The main content tables of Point of Interest Table 682, Activity Table 684, and Activity Provider Table 688, may be frequently updated or may remain unchanged for years. The majority of this content is maintained by Service Providers but is optionally supplemented by centralized editors.

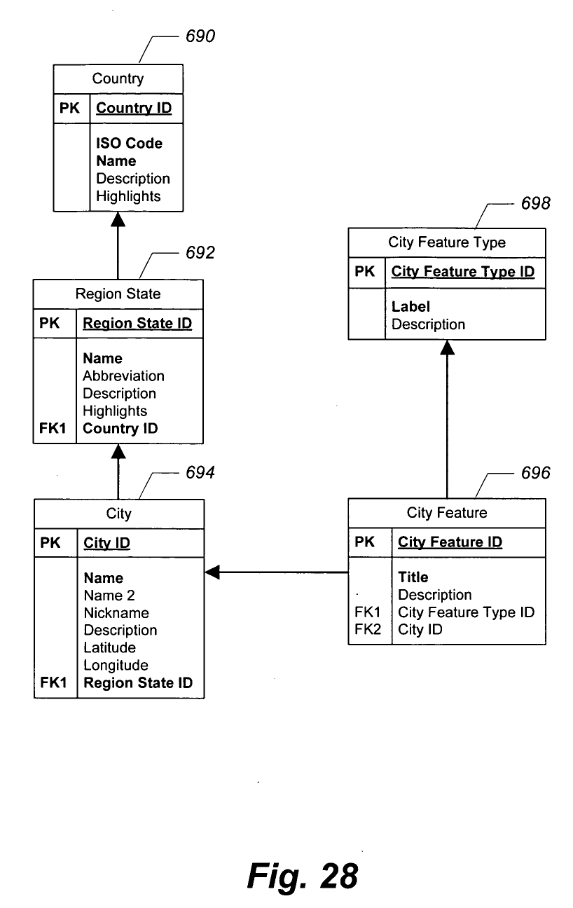

FIG. 28 describes database tables of a “Geography” subject area. These are all lookup tables and rarely changed. They consist of a Country Table 690, Region State Table 692, City Table 694, City Feature Table 696, and City Feature Type Table 698.

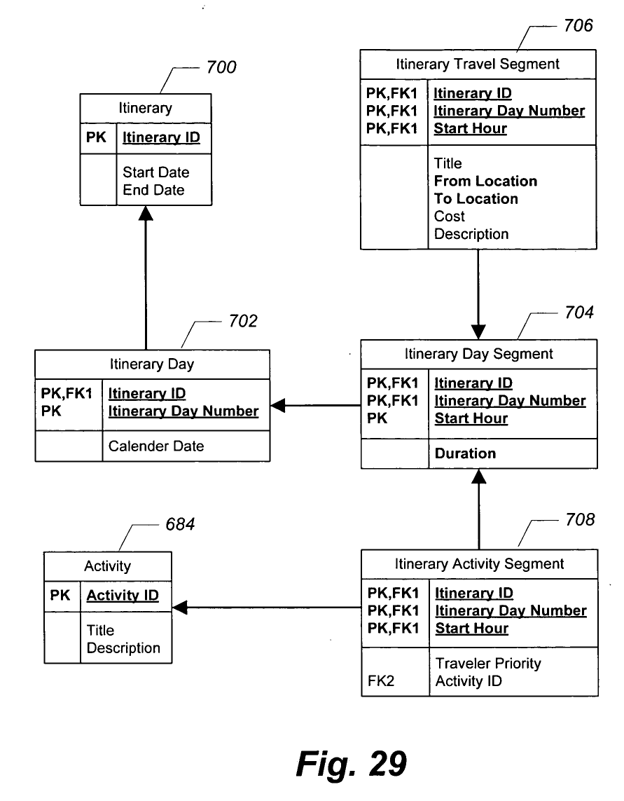

FIG. 29 describes database tables of an “Itinerary” subject area. These tables contain information that is created by the system as a traveler is creating their customized travel itinerary. They consist of an Itinerary Table 700, Itinerary Day Table 702, Itinerary Day Segment Table 704, Itinerary Travel Segment Table 706, and Itinerary Activity Segment Table 708.

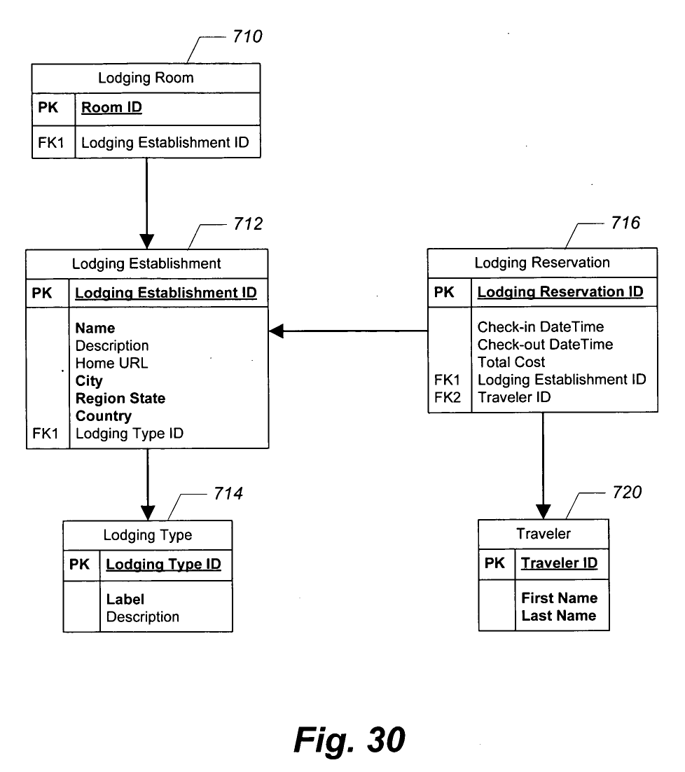

FIG. 30 describes database tables of a “Lodging” subject area. These tables include a Lodging Type Table 714, which is a lookup table and rarely changes. The main content tables of Lodging Room Table 710, Lodging Establishment Table 712, and Lodging Reservation Table 716, may be frequently updated or may remain unchanged for years. The majority of this content is maintained by Service Providers but is optionally supplemented by centralized editors. Traveler Table 720 is populated by the system when a traveler creates or modifies their profile and consists of information about a traveler including their demographics and preferences.

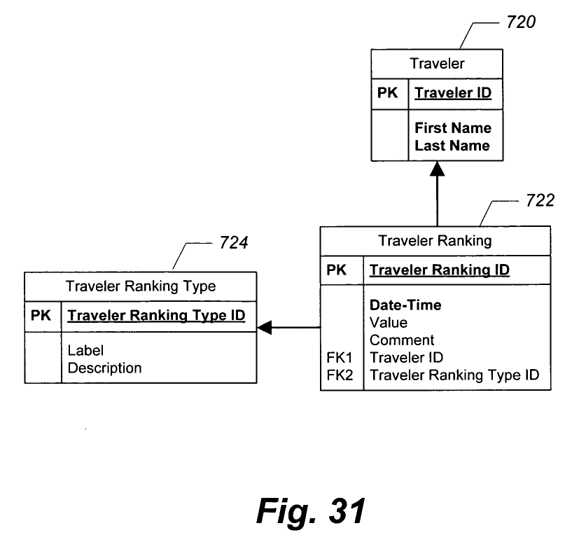

FIG. 31 describes database tables of a “Ranking” subject area. The lookup table Traveler Ranking Type Table 724 rarely changes. The main content table of Traveler Ranking Table 722 is populated by a traveler and Traveler Table 720 was previously described in the context of FIG. 30.

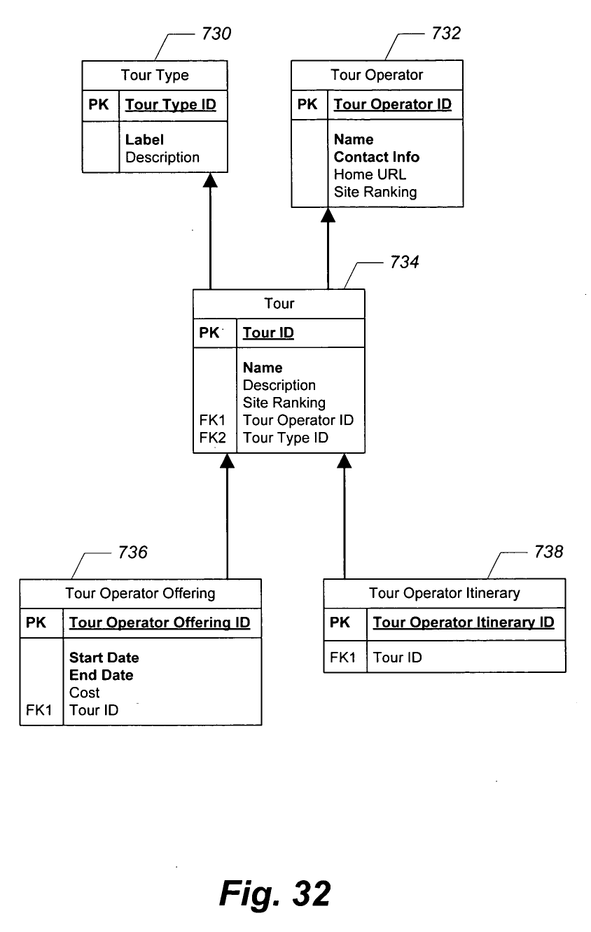

FIG. 32 describes database tables of a “Tour” subject area. The lookup table Tour Type Table 730 rarely changes. The main content tables of Tour Operator Table 732, Tour Table 734, Tour Operator Offering Table 736, and Tour Operator Itinerary Table 738, may be frequently updated or may remain unchanged for years. The majority of this content is maintained by Service Providers but is optionally supplemented by centralized editors.

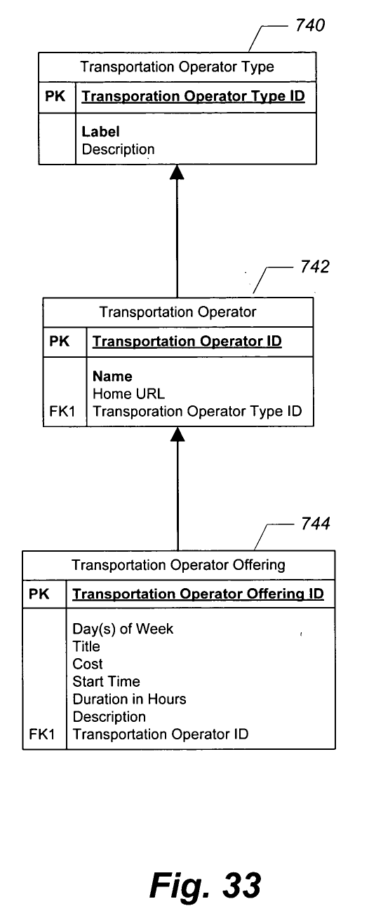

FIG. 33 describes database tables of the “Transportation” subject area. The lookup table Transportation Operator Type Table 740 rarely changes. The main content tables of Transportation Operator Table 742 and Transportation Operator Offering Table 744, may be frequently updated or may remain unchanged for years. The majority of this content is maintained by Service Providers but is optionally supplemented by centralized editors.

This concludes the discussion of basic components and features of a preferred embodiment. For embodiments combining further expansion of the system and method, please refer to the section titled, “Disclosure of the Invention.”

While a preferred embodiment of this disclosure includes the booking of transportation, lodging, and other activities and tours, as well as traveler ratings, it should be noted that embodiments of the disclosed system and method are contemplated that might not include transactions such as reservations and bookings. Such embodiments would provide customized information for assembling a customized travel itinerary and guidebook without reservations. It is also possible for embodiments not to include traveler ratings.

With regard to systems and components above referred to, but not otherwise specified or described in detail herein, the workings and specifications of such systems and components and the manner in which they may be made or assembled or used, both cooperatively with each other and with the other elements of the system and method described herein to effect the purposes herein disclosed, are all believed to be well within the knowledge of those skilled in the art. No concerted attempt to repeat here what is generally known to the artisan has therefore been made.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A system for providing a customized travel output for a traveler over a distributed network, the system comprising:
at least one computer hosting a travel site, operatively connected to the distributed network;
the travel site further operatively connected to at least one information source of travel content, the at least one information source of travel content residing on computer readable media;
at least one input device through which a traveler accesses the travel site and inputs data;
at least one output device through which a traveler accesses the travel site and receives selected output;
an application running on the travel site, wherein the application is adapted to:
a. process at least one traveler selected travel datum input;
b. find corresponding or related data from the at least one information source; and
c. generate at least one travel related output selected from the group of outputs consisting of a customized travel itinerary and a customized travel guide.

2. The system of claim 1 wherein the travel related output is a customized travel guide.

3. The system of claim 1 wherein the at least one travel related output is the customized itinerary, and the travel site application is further adapted to:
generate the customized travel itinerary in time period blocks;
receive further traveler choice input for each time period block; and
generate and output the itinerary according to the further traveler choice input.

4. The system of claim 1 wherein the travel site application is adapted to receive date specific datum that is input from a traveler, and, while finding corresponding or related data from the one or more information source, compare the date specific traveler datum to time constraints and time interferences in order to generate a date specific customized travel related output accommodating the date specific datum.

5. The system of claim 1 wherein the travel site application is further adapted to receive more than one traveler selected travel datum input, linked to a traveler selected priority assigned to each travel datum input and to generate the customized travel related output accommodating the priority assignments.

6. The system of claim 1 wherein the travel related output is the customized itinerary and the travel site application is further adapted to generate the customized travel itinerary in time period blocks and to reorder itinerary time period blocks according to the traveler's choice.

7. The system of claim 1 wherein the travel related output is the customized itinerary and the travel site application is further adapted to regenerate the customized travel itinerary according to input from a traveler instructing the application to adjust an itinerary time period duration to include selected traveler choice input for travel content.

8. The system of claim 1 wherein the travel site application is further adapted to:
store data related to a traveler's choices, a traveler's travel related output, and their own and other traveler's ratings and recommendations to one or more information source of travel content residing on computer readable media operatively connected to the travel site;
retrieve such data through comparison searching;
receive further traveler choice input relating to such data; and
generate the customized travel related output accommodating to the traveler's choice input.

9. The system of claim 1 further comprising a device through which a traveler accesses the travel site while traveling, and wherein the travel site application is further adapted to communicate selected updates and alarms pertaining to at least one of the travel related output through the device.

10. The system of claim 1 further comprising at least one input device through which data indicating geographic position is input and wherein the travel site application is further adapted to customize the travel related output taking into account a geographic position input.

11. A method for providing a selected travel related output for a traveler over a distributed network; the method comprising the steps of:
a. receiving from a traveler input of traveler related travel data;
b. accessing at least one information source of travel content, the data in the source selectably relating to travel content, service providers, application business rules, user (traveler) profiles, traveler choices, traveler priority assignments, previously generated travel itineraries and travel guides, traveler ratings and recommendations and any other such information as may be deemed useful in the creation of travel related outputs;
c. selecting from the at least one information source data corresponding or relating to selected traveler input; and
d. programmatically generating a travel related output, the output selected from the group of outputs consisting of a customized travel itinerary and a customized travel guide.

12. The method of claim 11 wherein the travel related output is a customized travel guide.

13. The method of claim 11 wherein the travel related output is the customized travel itinerary, and further comprises selected other data from the at least one information source, and further comprising in step (11.d), generating the customized travel itinerary in time period blocks and:
e. following step (11.d), displaying the itinerary and optional selected other data from the at least one information source to the traveler;
f. receiving further traveler choice input for at least one time period block; and
g. regenerating the itinerary to accommodate the further traveler choice input.

14. The method of claim 11 wherein the travel related output is the customized itinerary and wherein:
in step (11.a), a date specific traveler datum is received from the traveler;
in step (11.c), the selected data contains, in addition to the other data selectably relating to traveler input, date specific data relating to the selected travel content;
and, in step (11.d), the customized travel itinerary is programmatically generated using time constraint and time interference rules to accommodate the date specific data.

15. The method of claim 11 wherein the travel related output is the customized itinerary and further wherein:
in step (11.a), the traveler input includes a priority assignment to at least two input data; and
in step (11.d), the customized travel itinerary is generated to accommodate the priority assignments.

16. The method of claim 11 wherein the travel related output is the customized itinerary and further comprising in step (11.d), generating the customized travel itinerary in time period blocks, and:
e. receiving traveler sequence preference data for arranging the order of time period blocks;
f. regenerating the itinerary according to the traveler sequence preference input for the order.

17. The method of claim 11 wherein the travel related output is the customized itinerary and further comprising
e. following step (11.d), receiving instructions from the traveler to adjust an itinerary time period duration in order to include selected traveler choice input for travel content; and
f. regenerating the itinerary according to traveler choice input to accommodate such instructions.

18. The method of claim 11 further comprising:
in step (11.c), data is selected from the group of data consisting of a traveler's prior choices, a traveler's previously generated travel related output, and their own and other traveler's ratings and recommendations;
e. between steps (11.c) and (11.d), using such data to output travel suggestions and recommendations to the traveler;
f. between steps (11.c) and (11.d), receiving from the traveler a choice input from such travel suggestions and recommendations; and
in step (11.d), generating the customized travel itinerary to accommodate such traveler choice input.

19. The method of claim 11 further comprising, following step (11.d):
e. accessing at least one information source of travel content, the data relating to a previously generated travel related output for a traveler;
f. comparing the travel output data linked to a traveler with the data accessed in step (19e), and if the data is not in agreement, generating selected updates and alarms; and
g. outputting selected updates and alarms to the traveler.

20. The method of claim 11 further comprising, following step (11.d):
e. accessing data indicating a traveler's geographic position from a traveler while the traveler is traveling;
f. displaying to the traveler selected portions of the customized travel itinerary and guide, the selected portions particularly related to the geographic position.
